(19) United States
(12) Patent Application Publication
(10) Pub. No.: US 2021/0123558 A1
(43) Pub. Date: Apr. 29, 2021

(54) HIGH-PERFORMANCE SUB-AMBIENT RADIATIVE COOLING ENABLED BY OPTICALLY SELECTIVE AND THERMALLY INSULATING POLYETHYLENE AEROGEL

(71) Applicant: Massachusetts Institute of Technology, Cambridge, MA (US)

(72) Inventors: Arny LEROY, Cambridge, MA (US); Bikram BHATIA, Cambridge, MA (US); Lin ZHAO, Revere, MA (US); Evelyn N. WANG, Cambridge, MA (US)

(21) Appl. No.: 17/006,826

(22) Filed: Aug. 29, 2020

Related U.S. Application Data
(60) Provisional application No. 62/927,592, filed on Oct. 29, 2019.

(51) Int. Cl. F16L 59/02; F25B 17/08; F25B 27/00; C09D 5/33; C09D 123/06; C09D 7/61; F16L 59/08

(52) U.S. Cl. CPC F16L 59/028; F25B 17/08; F25B 27/007; F16L 59/08; C09D 123/06; C09D 7/61; C09D 5/004

(57) ABSTRACT

Recent progress in passive radiative cooling technologies have significantly improved cooling performance under direct sunlight. Performance of existing passive radiative coolers for air conditioning and portable refrigeration applications can be improved with a material that is solar reflective and infrared transparent that can also have a low thermal conductivity.

### CLAIM OF PRIORITY

This application claims priority to U.S. Provisional Patent Application No. 62/927,592, filed Oct. 29, 2019, which is incorporated by reference in its entirety.

### STATEMENT REGARDING FEDERALLY SPONSORED RESEARCH OR DEVELOPMENT

This invention was made with Government support under Grant No. DE-SC0001299 awarded by the Department of Energy. The Government has certain rights in the invention.

### TECHNICAL FIELD

This invention relates to radiative cooling structures and compositions.

### BACKGROUND

Sub-ambient cooling is vital for minimizing food shortage, promoting human well-being and driving sustainable economic growth [1]. Lack of and inadequate refrigeration of perishable food products in developing countries is still responsible for more than 40% of post-harvest food spoilage, leading to unnecessary greenhouse gas emissions, biodiversity and habitat loss as well as water consumption [2]. Moreover, air conditioning use in buildings is poised to surge in hotter parts of the world with growing populations and economic activity, further increasing the world's energy consumption and CO₂ emissions [1]. Fortunately, passive, affordable and more efficient cooling solutions have the potential to reduce food spoilage as well as meet space cooling energy needs without any CO₂ emissions. One approach that has generated significant interest in recent years is radiative cooling [3-23]—a passive cooling solution that relies on the natural emission of infrared (IR) radiation of terrestrial objects to the cold (3 K) outer space through the infrared (IR) transparent window of the atmosphere (8-13 μm).

By radiatively rejecting heat to space, radiative cooling theoretically has the potential to passively cool down a surface (emitter) facing the sky to more than ˜50° C. below ambient and achieve cooling power P_{cool}>100 W/m² at ambient temperature [12]. However, experimentally achieving sub-ambient cooling or significant cooling power under direct sunlight (global horizontal irradiance [GHI] Iₛᵤₙ˜1000 W/m²) has proven challenging due to high solar absorption (Pₛᵤₙ=(I−Rₛₒₗₐᵣ)Iₛᵤₙ) and parasitic heat gain (P_{parasitic}=h_{eff}(T_{amb}−Tₑₘᵢₜₜₑᵣ))—respectively characterized by the solar reflectivity Rₛₒₗₐᵣ of the emitter and the effective heat transfer coefficient h_{eff} between the emitter at temperature Tₑₘᵢₜₜₑᵣ and its environment at T_{amb}. The influence of Rₛₒₗₐᵣ and h_{eff} on the radiative cooling power is shown in FIG. 7.

Recent work on passive daytime radiative cooling has made remarkable progress in the design of emitters, demonstrating high solar reflectivity (Rₛₒₗₐᵣ=94-99%) as well as high mid-infrared emissivity (εI_{R}=60-97%) that has enabled cooling up to 10.6° C. below ambient under direct sunlight [19]. These performance enhancements were achieved primarily through the proposed use of 1-D [9, 12, 14], 2-D [11, 24] and 3-D [8] photonic structures, metamaterials [13, 19, 25], hierarchically porous polymeric materials [22], pigmented paints [4] and even gases such as C₂H₄ [5] and NH₃ [26]. In addition, several approaches to reduce the parasitic heat transfer P_{parasitic} between the cold emitter and its warmer surrounding environment have been proposed. These include a vacuum chamber to suppress convection heat transfer which enabled a record low h_{eff}=0.2-0.3 W/m²K [12, 27], although at the expense of cost and scalability. More robust, scalable and cheaper solutions have also been proposed that rely on using IR transparent convection covers such as thin polyethylene films [4-6, 9, 11, 15, 17, 19], corrugated structures [28] and meshes [29], as well as ZnSe [30], CdS [31], Ge [27] or Si [27] windows placed over the emitter. Despite the recent advances, solar absorption still induces a 10-60% reduction in cooling power at peak solar irradiance (i.e., 10-60 W/m² out of the ˜100 W/m²). In addition, high parasitic heat gain (typical h_{eff}=3-10 W/m²K for non-vacuum systems) rapidly become dominant at sub-ambient temperatures, limiting the minimum achievable temperature to only ˜10° C. below ambient.

### SUMMARY

This Summary introduces a selection of concepts in simplified form that are described further below in the Detailed Description. This Summary neither identifies key or essential features, nor limits the scope, of the claimed subject matter.

While most of the previous work has focused on either reducing solar absorption or parasitic heat gain, a solution that addresses both could enable simpler and higher performance radiative cooling. To tackle this challenge, an optically selective and thermally insulating (OSTI) emitter cover is presented in FIG. 1 [18, 20].

By taking advantage of the cover's added thermal conduction resistance between the emitter and the ambient (i.e., reduced h_{eff}) as well as its selective reflectance and transmittance (i.e., high solar reflectivity Rₛₒₗₐᵣ and infrared transmittance τ_{8-13 μm}), higher sub-ambient cooling power and colder stagnation temperatures may be achieved. It is demonstrated that deep sub-ambient radiative cooling using custom-fabricated polyethylene aerogel (PEA), a thermally insulating, solar reflecting and infrared transmitting material. The fabrication and corresponding optical and thermal properties of PEA are described herein. Using experimentally determined optical properties of the fabricated PEA and a robust theoretical model that accounts for radiative and conductive transport within the PEA, it is shown that the approach has the potential to achieve sub-ambient cooling of up to 7° C. under 1000 W/m² of direct sunlight and U.S. Standard Atmosphere 1976 [32], beating a selective emitter alone by more than 4° C. It is demonstrated that using PEA enables the use of simpler emitters due to the optical selectivity of the cover, while opening up a wide regime of sub-ambient temperatures and cooling powers that were not previously achievable. Finally, using an experimental setup and the fabricated PEA, a maximum ambient temperature daytime cooling power of 96 W/m² and a sub-ambient cooling as high as 13° C. around solar noon (1123 W/m² GHI) is shown, a more than 22% increase in emitter sub-cooling under direct sunlight over previously reported work [19] operating under similar experimental conditions (around solar noon under direct sunlight or without a solar shade casting a shade on the emitter and in air). These theoretical and experimental results demonstrate the potential of OSTI covers for simple and high-performance radiative cooling, that could improve the performance of existing radiative coolers as well as enable next-generation passive cooling systems.

In one aspect, a polyethylene aerogel can be formed from an initial polymer concentration selected to maximize solar reflectivity, infrared transmittance and structural integrity of the gel.

In another aspect, a material can be an optically selective and thermally insulating polyethylene aerogel.

In another aspect, a radiative cooling system can include the optically selective and thermally insulating polyethylene aerogel described herein.

In another aspect, a method of radiative cooling can include the optically selective and thermally insulating polyethylene aerogel as described herein on a surface of a radiation emitter.

In another aspect, a method of making a radiative cooler can include providing the optically selective and thermally insulating polyethylene aerogel as described herein on a surface of a radiation emitter.

In certain circumstance, the optically selective and thermally insulating polyethylene aerogel can have a low thermal conductivity of approximately about 28±5 mW/mK.

In certain circumstance, the optically selective and thermally insulating polyethylene aerogel can have a thickness greater than about one-half centimeter.

In certain circumstance, the optically selective and thermally insulating polyethylene aerogel can have, in the atmospheric transparency spectral window of approximately 8-13 μm, a high transmittance, for example, a transmittance of greater than 50%, greater than 60%, greater than 70%, greater than 75%, greater than 80%, or greater than 90%.

In certain circumstance, the optically selective and thermally insulating polyethylene aerogel can be solar reflecting, infrared transparent and low thermal conductivity.

In certain circumstance, the optically selective and thermally insulating polyethylene aerogel can have a thickness between about 50 microns and about 100 mm, for example, a thickness greater than 100 microns and less than 35 mm.

In certain circumstance, the optically selective and thermally insulating polyethylene aerogel can have an average pore size of less than 10 microns, for example, less than 5 microns.

In certain circumstance, the optically selective and thermally insulating polyethylene aerogel can include a dopant dispersed in the aerogel.

In certain circumstance, the dopant can include a material that has low absorption in the 8-13 μm range.

In certain circumstance, the dopant can include a plurality of particles. The plurality of particles can be distributed evenly throughout the aerogel or in a gradient through a thickness of the aerogel. The plurality of particles can have an average diameter of between 0.1 and 2 microns.

In certain circumstance, the dopant can include ZnS, TiO₂, ZnO, ZnSe, KBr, NaCl, ZrO₂, GeAsSe, BaF₂, CsI, CdTe, diamond, Ge, Si, or AgCl.

The following Detailed Description references the accompanying drawings which form a part this application, and which show, by way of illustration, specific example implementations. Other implementations may be made without departing from the scope of the disclosure.

### BRIEF DESCRIPTION OF THE DRAWINGS

FIG. 1 is a schematic of the proposed approach. (A) Traditional approach to radiative cooling. An emitter facing the sky is exposed to solar irradiation and parasitic heat gain from the ambient air due to convection. (B) Proposed approach where an optically selective and thermally insulating (OSTI) cover is placed on top of the emitter. This insulation reduces parasitic heat gain as well as the solar irradiation reaching the emitter, enabling lower emitter temperatures and higher sub-ambient cooling power.

FIG. 2 is an image (A) and graph (B) describing a polyethylene aerogel.

FIG. 3 includes graphs illustrating performance of radiative coolers with PEA. (A) Daytime cooling performance of a semi-ideal selective emitter (Rₛₒₗₐᵣ=1−αₛₒₗₐᵣ=0.97 and ε_{IR}=0.9) at different temperatures (ΔT=Tₑₘᵢₜₜₑᵣ−T_{amb}). The maximum cooling power is shown by a solid point for each emitter temperature curve. An optimal aerogel thickness exists to achieve the maximum cooling power at a given emitter temperature. The results shown were calculated based on the U.S. Standard Atmosphere 1976. Atmospheric conditions specific to a location and time such as humidity and cloud cover can significantly affect the results and should be accounted for accordingly [19]. (B) Results for nighttime cooling performance. Higher cooling power and lower emitter temperatures can be achieved due to the absence of solar irradiation.

FIG. 4 is a diagram of an experimental setup. (A) Schematic of the radiative cooler. A PEA/emitter/heater assembly is placed on top of a vacuum insulation panel (VIP) which sits inside a thermally-insulating foam (FOAMULAR® 150) box. The box is covered with Tefzel™ coated polished aluminum sheets to minimize solar heating. The emitter/heater consists of two separate parts—the main emitter/heater and the guard emitter/heater (see inset). (B) Picture of the setup consisting of two identical devices (left: device with PEA, right: device with no PEA). A DAQ (enclosed in an aluminum box) is also visible. More pictures showing details of the experimental location and setup are included in FIG. 9.

FIG. 5 includes graphs of stagnation temperature of a radiative cooler.

FIG. 6 includes graphs of cooling performance of a radiative cooler.

FIG. 7 includes graphs of influence of system non-idealities. (A) Influence of emitter solar reflectivity Rₛₒₗₐᵣ on cooling power and minimum emitter sub-cooling (defined as the emitter sub-cooling at P_{cool}=0 W/m²). Lower solar reflectivity reduces cooling power and sub-ambient cooling. (B) Influence of the effective heat transfer coefficient h_{eff} between the ambient and the emitter, on the cooling power and minimum emitter sub-cooling. Higher h_{eff} reduces cooling power and sub-ambient cooling.

FIG. 8 is a graph of solar absorption at the emitter. Absorption of incident solar irradiance (Iₛᵤₙ=1000 W/m²) at an emitter with solar weighted reflectivity Rₛₒₗₐᵣ and with a 20 mm thick PEA. For a black emitter (Rₛₒₗₐᵣ=0), the PEA reduces solar absorption at the emitter by 98.9% as compared to an emitter having no PEA. Higher Rₛₒₗₐᵣ further reduces solar absorption at the emitter from 11.2 W/m² at Rₛₒₗₐᵣ=0, to 6.1 W/m² at Rₛₒₗₐᵣ=0.97 to 0 W/m² at Rₛₒₗₐᵣ=1. In practice, selective emitters typically have Rₛₒₗₐᵣ≤0.97 (Rₛₒₗₐᵣ>0.97 shown by red area), meaning that the emitter solar reflectivity is mostly irrelevant due to the optical selectivity of the PEA. Thus, when using PEA, the optical selectivity of the emitter becomes less important and simpler and cheaper emitters may be used.

FIG. 9 illustrates an example experimental setup. (A) The experiments were done in San Pedro de Atacama, Chile at an altitude of 2476 m. The picture shows the location of the experiment along with solar (pyranometer and rotating shadowband radiometer) and weather monitoring equipment, the data acquisition system and the radiative coolers. (B) Top view of a radiative cooling device showing the main and guard emitters, the VIP, electrical wires for the heaters and thermocouples as well as the location of the thermocouples beneath the emitters.

FIG. 10 is a graph of selective emitter emissivity. The selective emitter used in the experiments was made from a 3M Enhanced Specular Reflector (ESR) film, attached to a polished 0.5 mm thick aluminum sheet using an optically clear adhesive (Thorlabs OCA8146-2). The emitter was measured to have a solar weighted reflectivity Rₛₒₗₐᵣ=0.942, and an emissivity of ε_{8-13 μm}=0.878 within the atmospheric spectral window.

FIG. 11 is a graph of influence of PEA thickness.

FIG. 12 includes graphs of cooling performance of a radiative cooler in Cambridge, Mass. (A) Stagnation temperature of two devices (12 mm thick PEA and no PEA) over a 24-h period in late October in Cambridge, Mass. The device with the PEA achieves 9.8° C. sub-ambient cooling around solar noon (30-minute average around 12:43; GHI=747 W/m²) compared to 1.1° C. without the PEA. (B) Wind speed and solar irradiation during the stagnation temperature experiment. (C) Cooling power of two devices (18 mm thick PEA and no PEA) as a function of the emitter sub-cooling in Cambridge, Mass. (D) Cooling power of two devices (6 mm thick PEA and 12 mm thick PEA) as a function of the emitter sub-cooling in Cambridge, Mass.

FIG. 13 includes graphs of experimental comparison of selective and black emitters with PEA. (A) Image of devices (selective emitter—left and black emitter—right) without the PEA. (B) Spectral emissivity of selective and black emitters. (C) Stagnation temperature of the two emitters, both with 18 mm thick PEA over a 24-h period in June in Cambridge, Mass. Both devices achieved similar sub-ambient cooling throughout the day and night, demonstrating a difference of only 1.5° C. around solar noon (30-minute average around 12:43; GHI=948 W/m²) and 0.6° C. around midnight (30-minute average around 0:00). (D) Wind speed and solar irradiation during the stagnation temperature experiment. (E) Cooling power of the two emitters, both with 18 mm thick PEA as a function of the emitter sub-cooling in Cambridge, Mass. Both emitters show similar cooling power due to strong suppression of solar irradiation by the PEA on top of the emitters. (F) Stagnation temperature of the two emitters with no PEA close to solar noon. The black emitter quickly heated up to over 50° C. after the aerogel was removed at 12:45.

FIG. 14 is a diagram of an iterative process for cooling power modeling.

FIG. 15 includes graphs of optical properties of PEA. (A) Optical transmittance (direct-direct and direct-hemispherical) and reflectance (direct-hemispherical) of a 6 mm thick PEA sample. (B) Calculated optical hemispherical transmittance and reflectance in the solar (solid line) and mid-infrared (8-13 μm; 300 K blackbody weighted; dashed line) spectrum of the PEA for a range of thicknesses.

FIG. 16A shows a scanning electron microscopy image of the PEA porous structure.

FIG. 16B shows a hemispherical transmittance of 5 mm thick PEA samples at varying densities.

FIG. 17 depicts thermal transport in PEA due to simultaneous radiative transfer and conduction in the gas and solid.

FIG. 18 depicts spectral emissivity of the boundaries in the thermal conductivity measurements measured using Fourier-Transform Infrared spectroscopy.

FIG. 19 depicts thermal conductivity with high emissivity boundaries for a 15.6 kg/m³ density PEA sample filled with three different gases at pressures varying from vacuum (10⁻³ Pa) to atmospheric pressure (10⁵ Pa).

FIG. 20 depicts the influence of boundary emissivity on the thermal conductivity of PEA (samples #2 and #7 for high and low emissivity boundaries respectively).

FIGS. 21A-21B depicts thermal conductivity of PEA samples of various densities in nitrogen as a function of gas pressure (10⁻³ to 10⁵ Pa) for (FIG. 21A) high emissivity and (FIG. 21B) low emissivity boundaries. Dashed lines are guide to the eyes only.

FIGS. 22A-22C depicts contribution of the three components of thermal conductivity: (FIG. 22A) gaseous (in nitrogen; only low emissivity boundaries measurements are shown to reduce cluttering), (FIG. 22B) radiative and (FIG. 22C) solid. The area in FIG. 22B represents the modeled range of kᵣ for different PEA thicknesses to account for the variable thickness of the samples experimentally tested.

FIGS. 23A-23C show solar performance. FIGS. 23A-23B depict optically selective and thermally insulating (OSTI) covers enable sub-ambient radiative cooling of the emitter by minimizing parasitic solar absorption and heat gain from the ambient air. The non-zero solar transmittance of the OSTI cover limits the cooling performance of the emitter. Solar scattering dopants in the OSTI cover could provide a way to increase solar reflectivity and thus improve cooling performance. FIG. 23C shows a comparison of the transmittance of an ideal (Ideal cover) and existing 5 mm thick polyethylene aerogel (PEA) cover.

FIGS. 24A-24B show transmittance and reflectance data. FIG. 24A depicts modeled hemispherical transmittance (τ; top) and reflectance (ρ; bottom) of PEA pigmented with ZnS particles of different diameters. All curves assume a sample thickness of 5 mm and a ZnS concentration of 30 kg/m³. FIG. 24B depicts modeled solar- (τₛₒₗₐᵣ; top) and infrared- (τ_{IR}; bottom) weighted transmittance of the ZnS doped PEA as a function of ZnS concentration and particle diameter.

FIGS. 25A-25B show transmittance and reflectance data. FIG. 25A depicts Experimental hemispherical transmittance (τ) and reflectance (ρ) of a 2-mm thick PEA doped with ZnS particles at different concentrations. The PEA-only density was measured to be 15 kg/m³. FIG. 25B shows experimental solar- (τₛₒₗₐᵣ; top) and infrared- (τ_{IR}; bottom) weighted transmittance and reflectance density. Theoretical simulations are represented by a solid line for the pure ZnS powder.

FIGS. 26A-26B show cooling power as a function of ZnS concentration (C_{ZnS}) and particle diameter (d_{ZnS}) with a 5 mm thick cover and (FIG. 26A) a blackbody emitter and (FIG. 26B) an ideal selective emitter with emissivity ε=1 between 8-13 μm and reflectivity ρ=1 at all other wavelengths. Incident solar irradiance of 1000 W/m² normal to the emitter and an emitter temperature 5 K below ambient (T_{ambient}=298.15 K) are assumed.

FIGS. 27A-27D depict the effect of particle distribution profiles. FIG. 27A shows ZnS distribution profiles within PEA. FIG. 27B shows temperature distribution within the cover for different ZnS distributions with the air side represented by sample depth=0 mm and the emitter-side by sample depth=5 mm. FIG. 27C shows cooling power of a blackbody emitter+5 mm thick PEA having different distributions of ZnS within it as a function of ΔT=Tₑₘᵢₜₜₑᵣ−T_{ambient}. FIG. 27D shows optimized distribution of ZnS that maximizes the cooling power at ΔT=−5 K, achieving 27.6 W/m² of cooling as opposed to 22.1 W/m² with a constant ZnS profile.

FIGS. 28A-28B depict transmittance and optical properties. FIG. 28A shows transmittance of PEA samples of different thicknesses. Spectra were calculated using the RTE model based on the experimentally determined optical properties of PEA. FIG. 28B shows solar and IR (8-13 μm) weighed optical properties of PEA as a function of thickness.

FIG. 29A depicts real (top) and imaginary (bottom) part of the refractive index of ZnS.

FIG. 29B depicts scattering (C_{sca}; top) and absorption (C_{abs}; bottom) cross section of ZnS particles of different diameters.

FIG. 30 depicts a radiative cooling layer as described herein.

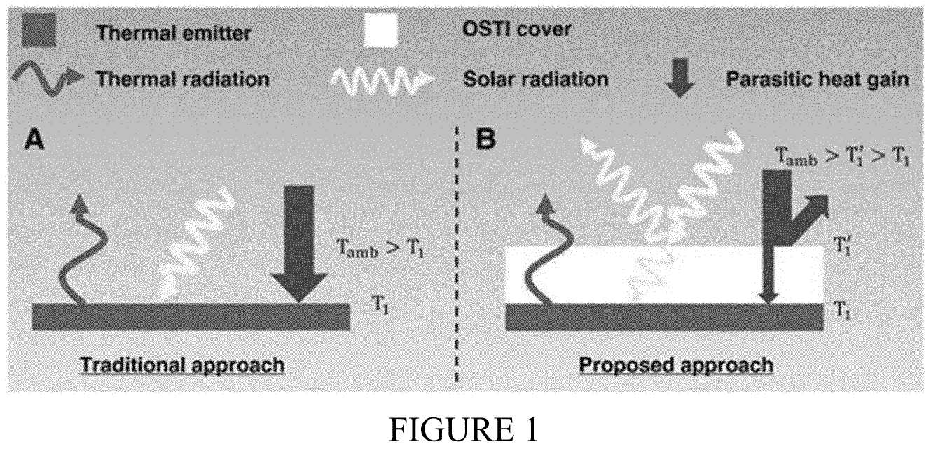

### DETAILED DESCRIPTION

Reference numbers in brackets “[ ]” herein refer to the corresponding literature listed in the attached Bibliography which forms a part of this Specification, and the literature is incorporated by reference herein.

In general, an aerogel can be formed from an initial material concentration selected to maximize solar reflectivity, infrared transmittance and structural integrity of the gel. Any polymer that has infrared transmittance between 8-13 μm can be used to form the aerogel. For example, in the atmospheric transparency spectral window of approximately 8-13 μm, the aerogel can have a high transmittance, such as a transmittance of greater than 50%, or greater than 70%.

For example, the material can be a polyolefin, for example, a polyethylene or a polypropylene. Alternatively, the material can be any IR transparent material such as GeAsSe, BaF₂, CsI, CdTe, diamond, Ge, Si, AgCl, ZnS, ZnSe, KBr, KCl, CsBr, BrITl₂, or NaCl.

In certain circumstances, the aerogel can be an optically selective and thermally insulating polyethylene or polypropylene aerogel.

In certain circumstances, the aerogel can have a low thermal conductivity. For example, the thermal conductivity can be approximately about 28±5 mW/mK or less. The aerogel can have a higher thermal conductivity if the density of the aerogel is increased or the base material is altered. Alternatively, if the thermal conductivity is higher, a thicker layer can have the same overall insulative properties.

In certain circumstances, the aerogel can have a thickness greater than about one-half centimeter.

In certain circumstances, the aerogel can have a thickness less than about 100 mm, for example, 35 mm or less. The thickness can be between about 5 mm and about 20 mm or a thickness between about 6 mm and about 18 mm. The polyethylene aerogel can have a thickness between about 50 microns and about 100 mm, for example, a thickness greater than 100 microns and less than 35 mm. In certain circumstances, the thickness can be less than 20 mm.

In certain circumstances, the aerogel can have an average pore size of less than 10 microns, for example, less than 5 micron or less than 1 micron. The average pore size can be approximately about 0.5 microns. The pore size distribution does not need to be even throughout the thickness of the aerogel. For example, the aerogel can have smaller pores on one side to maximize solar scattering and larger pores on the other side to minimize the density.

In order for the material to be considered an aerogel, the material can have thermal insulation properties comparable to air.

In certain circumstances, the aerogel can be solar reflecting (for example, approximately 92.2% solar weighted reflectance at 6 mm thick), infrared transparent (for example, approximately 79.9% transmittance between 8-13 μm at 6 mm thick) and low thermal conductivity (for example, approximately k_{PEA}=28 mW/mK). As described herein, the thermal conductivity of the material described herein is the solid and gaseous conductivity within the material.

In certain circumstances, a radiative cooling system can include an optically selective and thermally insulating polyethylene aerogel.

In certain circumstances, a dopant can be dispersed in the aerogel. The dopant can significantly improve their optical selectivity by reducing solar transmittance while maintaining high infrared transmittance. In certain circumstances, the dopant can include a material that has low absorption in the 8-13 μm range. A high refractive index in the solar spectrum can also be beneficial but not as important as the low absorption in the 8-13 μm range. A dopant that does not completely suppress infrared transmittance of the aerogel can be suitable for the purpose described herein. For example, the dopant can include ZnS, TiO₂, ZnO, ZnSe, KBr, NaCl, ZrO₂, GeAsSe, BaF₂, CsI, CdTe, diamond, Ge, Si, or AgCl. In certain circumstances, the dopant can include ZnS. In certain circumstances, the dopant can be a combination of materials, for example, a combination of one or more of ZnS, TiO₂, ZnO, ZnSe, KBr, NaCl, Zr₂, GeAsSe, BaF₂, CsI, CdTe, diamond, Ge, Si, and AgCl.

In certain circumstances, the dopant can include a plurality of particles. The plurality of particles can have an average diameter of between 0.1 and 2 microns. For example, the particles can have an average diameter of 0.1, 0.2, 0.3, 0.4, 0.5, 0.6, 0.7, 0.8, 0.9, 1.0, 1.1, 1.2, 1.3, 1.4 or 1.5 microns. The particles can be nanoparticles (i.e., having a size less than one micron).

As depicted in FIG. 30, radiative cooler 1 can include aerogel 10 on or adjacent to a surface of an emitter 20. In certain circumstances (not shown) a small air gap can be present between the aerogel and the emitter. The air gap can be sealed from the ambient atmosphere so that air in the gap cannot exchange. The emitter can be a black-body emitter or a selective emitter, for example, an emitter that emits some infrared radiation in the 8-13 μm range.

Aerogel 10 can include a dopant 30 (for example, a plurality of dopant particles). The dopant can be substantially evenly distributed throughout volume of aerogel 10. Alternatively the dopant can have concentration gradient from aerogel surface 50 to a surface 40 of the emitter 20. In certain circumstances, the gradient includes a higher dopant concentration adjacent to the surface 50 of the aerogel.

In certain circumstances, a radiative cooling system can include the optically selective and thermally insulating polyethylene aerogel. The aerogel can be on a surface of a radiation emitter, for example, a black-body emitter. Accordingly, a method of radiative cooling can include providing the optically selective and thermally insulating polyethylene aerogel on a surface of a radiation emitter. In addition, a method of making a radiative cooler can include providing the optically selective and thermally insulating polyethylene aerogel on a surface of a radiation emitter. The method can include supercritical drying of a polymer solution to remove solvent and create a solid having a porous structure. The porous structure can have average diameters of less than 10 microns.

Recent progress in passive radiative cooling technologies have significantly improved cooling performance under direct sunlight. Yet, experimental demonstrations of daytime radiative cooling still severely underperform in comparison with the theoretical potential due to significant solar absorption and poor thermal insulation at the emitter. A polyethylene aerogel (PEA) that is solar reflecting (92.2% solar weighted reflectance at 6 mm thick), infrared transparent (79.9% transmittance between 8-13 μm at 6 mm thick) and low thermal conductivity (kPEA=28 mW/mK) material, can be integrated with existing emitters to address these challenges. Using an experimental setup that includes the custom-fabricated PEA, a daytime ambient temperature cooling power of 96 W/m² and passive cooling up to 13° C. below ambient temperature around solar noon has been demonstrated. This work could significantly improve the performance of existing passive radiative coolers for air conditioning and portable refrigeration applications.

In other work, thin (<100 μm) polyethylene [33] and nanoporous polyethylene [34] films have been widely used as convection covers due to their low cost and good infrared transmittance. However, their high density has precluded the use of thicker films that could provide additional thermal insulation to the emitter due to dominant infrared absorption. By combining the advantages of polyethylene with that of aerogels, a class of materials with high porosity, ultra-low thermal conductivity and density, PEA can be used as a highly insulating and infrared-transparent cover for radiative cooling.

A PEA fabrication utilizes a process based on the thermally induced phase separation (TIPS) of a homogeneous polyethylene/paraffin oil mixture [35, 36] followed by a solvent extraction by supercritical point drying. By controlling the initial polymer concentration, the TIPS process allows creation of a highly porous (>0.9), low density (˜10 kg/m³) and highly infrared transparent and solar reflecting material, while the critical point drying enabled solvent extraction without damaging the porous structure. More details on the fabrication of PEA are given in a “Methods” section below.

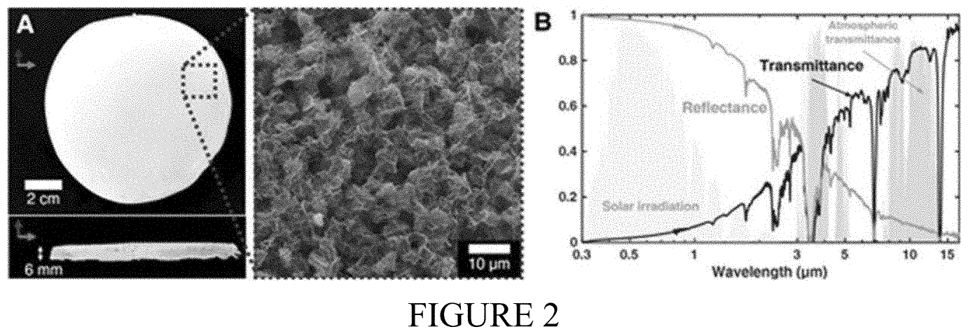

The optical and thermal properties of this fabricated PEA support its application as an OSTI cover for radiative cooling. In FIG. 2, at “A”, shows an image of a representative PEA sample, 10 cm in diameter and 6 mm thick, along with a scanning electron microscope (SEM) image of its internal porous structure. The inset shows the SEM image at a magnification of 1,500×. At “B” is shown hemispherical transmittance and reflectance of a 6 mm thick PEA sample along with the normalized AM1.5 solar spectrum and the atmospheric transmittance (U.S. Standard Atmosphere 1976).

Owing to its highly porous structure and low density (14±2 kg/m³), the PEA possesses a low thermal conductivity of 28±5 mW/mK, nearly equal to that of air (kₐᵢᵣ=26 mW/mK) due to negligible solid heat transfer through the polymer (see the “Methods” section below for more details on the custom guarded-hot-plate steady-state thermal conductivity setup used for thermal characterization). The optical reflectance and transmittance of the 6 mm thick PEA sample are also shown in FIG. 2, at “B”, along with the AM1.5 solar spectrum and a standard atmospheric transmittance (U.S. Standard Atmosphere 1976). The results show that in the atmospheric transparency spectral window (8-13 μm), the PEA possesses high transmittance (τ_{1-13 μm}=0.799). However, the PEA sample is strongly scattering at shorter wavelengths (0.3-2.5 μm) due to its porous structure, resulting in significant reflection of solar irradiation (Rₛₒₗₐᵣ=0.922). Strong absorption peaks at 3.5, 6.8 and 13.8 μm, characteristic to polyethylene, are due to asymmetric stretching, bending and wagging of CH₂ molecules [33]. Due to its characteristic porous structure and ultra-low density, PEA possesses exceptional optical and thermal properties, ideal for high-performance sub-ambient radiative cooling, even at large thicknesses (˜cm) which was not possible with previous materials such as nanoporous polyethylene [34].

Modeling the cooling potential of an emitter coupled with PEA

To accurately evaluate the performance of an emitter coupled with PEA, both conductive and radiative thermal transport are simultaneously considered. In fact, the thicker the PEA, the more it absorbs, emits and scatters light, which in turn affect the temperature profile within it and the corresponding conductive heat flux (i.e., parasitic heat gain P_{parasitic}). The contribution of the conductive and radiative heat fluxes as well as their interactions therefore affect the total heat flux at the emitter (i.e., emitter cooling power P_{cool}). To account for both effects, the steady-state 1-D heat transfer equation (HTE) within the PEA numerically solved:

$$- {k}_{PEA} \frac{{d}^{2} T}{{dx}^{2}} + \frac{{dq}_{r}}{dx} = 0 , \qquad ( 1 )$$

where k_{PEA} is the PEA thermal conductivity, x is the spatial coordinate along the thickness of the PEA, T is the spatial PEA temperature profile and qᵣ is the spatial radiative heat flux. The simplified HTE (Eq. 1) states that for energy to be conserved, the spatial rate of change of the conductive and radiative heat flux are of equal magnitude (but of different sign). Whereas the conductive term can be calculated from Fourier's law, the evaluation of the radiative term is more complex due to absorption, emission and multiple scattering, all occurring within the PEA and impacting the radiative flux at the emitter. The radiative heat flux qᵣ within the PEA is evaluated by numerically solving the radiative transfer equation (RTE) using the discrete ordinate method [37]. By independently solving for the conductive and radiative terms and iteratively evaluating the PEA temperature profile until the HTE was satisfied, the model calculates the PEA steady state temperature profile as well as conductive and radiative heat flux at all positions within the PEA. Finally, the emitter cooling power P_{cool} is calculated by summing the contribution of the conductive and radiative heat flux at the PEA/emitter boundary. Convection with the ambient air, solar irradiation and atmospheric emission were implemented as boundary conditions at the top of the PEA while a diffusely emitting and reflecting emitter at Tₑₘᵢₜₜₑᵣ were set as boundary conditions at the bottom of the PEA. The optical properties (scattering albedo, extinction coefficient and scattering phase function) of the PEA needed for the RTE were experimentally determined from reflectance and transmittance measurements by solving the inverse problem [38]. Additional details on the model are given in the supplementary information.

Cooling Performance Enhancement Using PEA

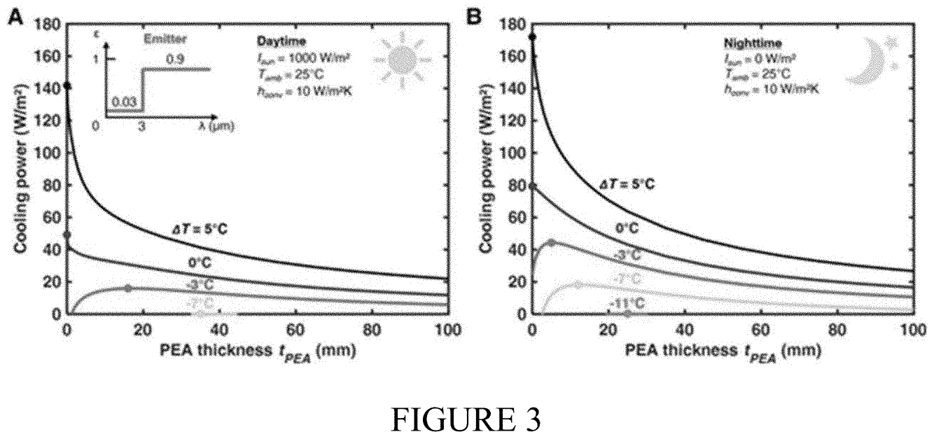

Using the developed model and experimentally determined optical properties of the PEA, the cooling power of any given emitter (with known spectral optical properties and temperature), ambient conditions (that include ambient temperature, spectral atmospheric transmittance, solar irradiation and convection coefficient with ambient air) and PEA thickness can be predicted. FIG. 3 shows the theoretical daytime (“A”) and nighttime (“B”) cooling power of a typical stepwise selective emitter (Rₛₒₗₐᵣ=1−αₛₒₗₐᵣ=0.97; ε_{IR}=0.9) facing a standard atmosphere (U.S. Standard Atmosphere 1976) at different temperatures ΔT=Tₑₘᵢₜₜₑᵣ−T_{amb} combined with PEA of varying thickness t_{PEA}. Results show that in the absence of PEA (t_{PEA}=0 mm), significant sub-ambient temperatures (ΔT≤0° C.) are not achievable (i.e., P_{cool}<0 W/m²) due to dominant solar heating and parasitic heat gain. However, increasing t_{PEA} reduces solar absorption and parasitic heat gain at the emitter, enabling lower temperatures (up to ΔT=−7° C. and ΔT=−11° C. for daytime and nighttime respectively) and higher cooling powers. A maximum cooling power (indicated by the dot symbol) is also observed for each ΔT curves, highlighting the compromise between the decreasing IR transmittance and increasing solar reflectance and thermal insulation associated with thicker PEA. Furthermore, an increasing t_{PEA} for ΔT>0° C. decreases P_{cool} as convection now positively contributes to the emitter cooling. In general, similar trends are observed between daytime and nighttime operation, although the nighttime performance allows us to decouple solar absorption in the PEA and emitter from the thermally insulating property of the PEA. Results presented in FIG. 3 can be strongly influenced by the atmospheric conditions specific to a location and time such as humidity and cloud cover and these conditions should therefore be accounted for [19]. Therefore, lower sub-ambient temperatures and higher cooling powers are possible for both daytime and nighttime operation when using an OSTI cover such as PEA.

Decoupling Cooling Performance from Emitter Solar Reflectivity

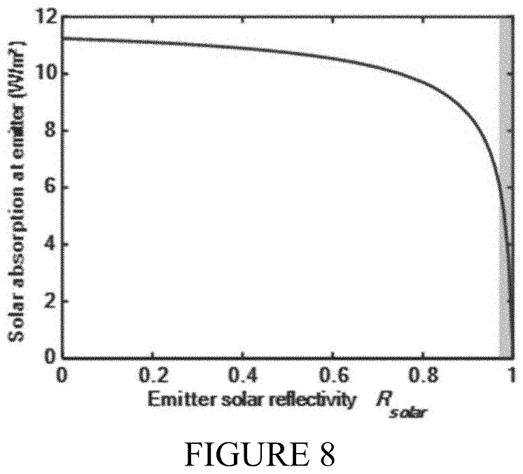

A further advantage of using an OSTI cover is that it relaxes the requirement to use a potentially complex and costly near-ideal solar reflecting emitter to achieve daytime radiative cooling. In fact, adding a 20 mm thick PEA to a black emitter reduces solar absorption by 98.9% (see FIG. 8), which is better or comparable to state-of-the-art selective emitters. Furthermore, when combined with that same thickness of PEA, increasing the emitter solar reflectivity Rₛₒₗₐᵣ from 0 to 0.97 (typical of existing selective emitters) only reduces solar absorption at the emitter by a further 0.5%, meaning that the optical selectivity of the emitter is no longer critical when combined with PEA. Using an OSTI cover could thus enable the use of simpler and lower cost emitters such as commercially available paints without compromising performance.

Experimental Design

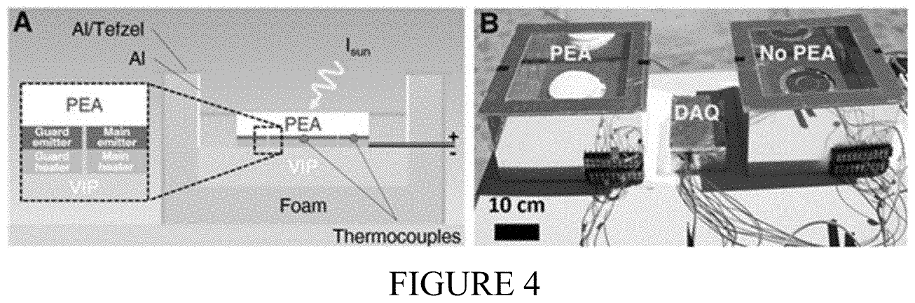

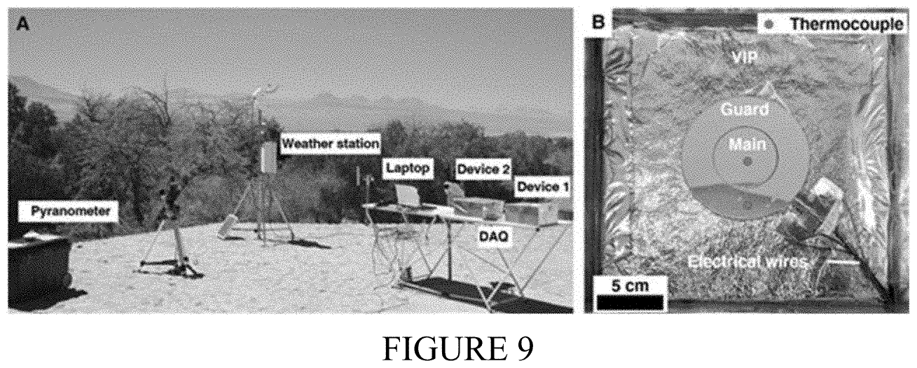

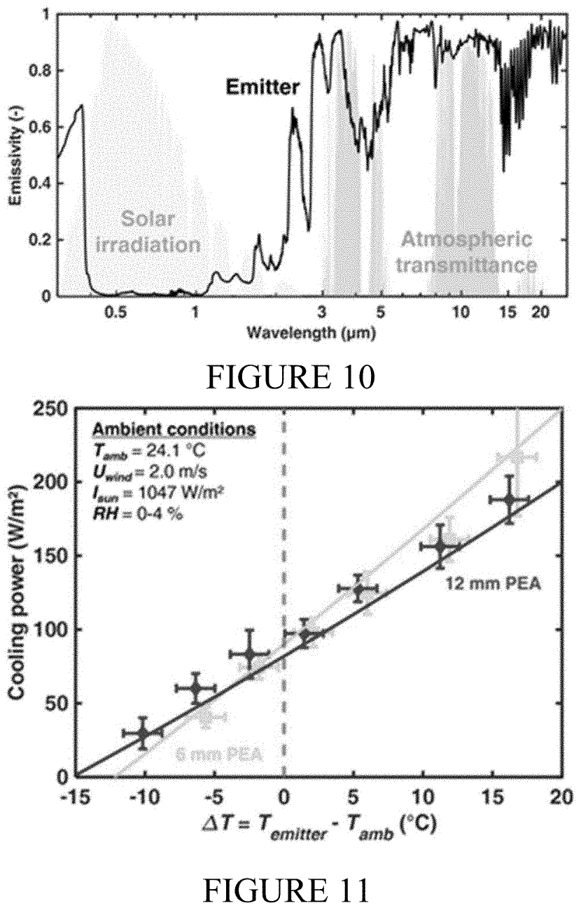

An experimental setup is shown in FIG. 4 and FIG. 9 which simultaneously compare the performance of two radiative coolers—one with PEA and one without. Each radiative cooler possessed an identical 10 cm diameter two-part selective emitter made from a 3M Enhanced Specular Reflector (ESR) film on top of polished aluminum (Rₛₒₗₐᵣ=0.942; ε_{8-13 μm}=0.893; see FIG. 10 for optical properties). The two parts of the emitter includes a 5 cm diameter main emitter in the center, surrounded by a 10 cm diameter guard emitter with a separation gap of 0.5 mm. The separation of the emitter in two parts is a similar approach to the one used in the guarded-hot-plate thermal conductivity measurement standard test method [39]. This approach limits any 2D heat transfer effects to the guard emitter and ensures 1D heat transfer at the main emitter, thus replicating the performance of a large-scale device not affected by side losses. Heaters as well as T-type thermocouples were attached to the back of the (main and guard) emitters to enable control and measurement of their temperature. Power supplies were used in a 4-wire and 2-wire configuration at the main and guard heaters respectively for accurate measurement and control of their power consumption. A 0.5 mm thick thermally conductive copper plate was also placed between each heater and emitter to minimize temperature gradients at the emitter. The emitter/heater assembly rested on top of a highly insulating vacuum insulation panel (VIP; Thermal Vision THRESHHOLD™; 23×23×5 cm; k_{VIP}=2.9 mW/mK) which in turn sat at the bottom of a polystyrene foam (FOAMULAR®150) box (30×30×15 cm), minimizing the parasitic heat gains at the backside of the emitter. The horizontal surfaces of the setups were covered with Tefzel™ coated aluminum to minimize parasitic solar heating of the box, and the inner vertical walls of the polystyrene foam box were covered with polished aluminum sheets to maximize the view factor between the emitter and the sky. Different thicknesses of PEA were achieved by stacking standard 6 mm thick samples. With two identical devices in which the PEA thickness can be controlled, the benefits of PEA for radiative cooling were directly evaluated validate the theoretical model.

Exemplary Experimental Results

A first experiment focused on measuring the minimum stagnation temperature of the two devices—one with 12 mm thick PEA and one without PEA—over a full 24-h cycle, demonstrating both the daytime and nighttime benefits of PEA. Both devices were placed next to each other and exposed to direct sunlight as shown in FIG. 4 at “B”.

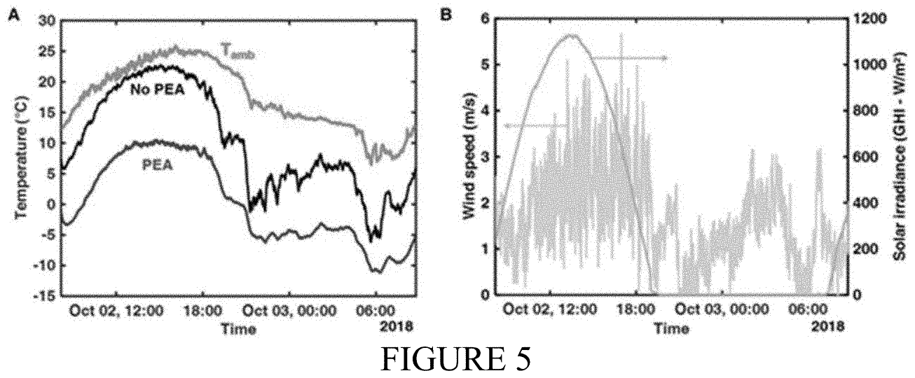

FIG. 5 at “A” shows the temperature of both devices (PEA and No PEA) as well as the ambient (T_{amb}) temperature during the 24-h cycle. More particularly, it shows stagnation temperature of two devices (12 mm thick PEA and no PEA) over a 24-h period in early October in San Pedro de Atacama, Chile. The device with the PEA achieves 13° C. sub-ambient cooling around solar noon (30-minute average around 13:22; GHI=1123 W/m²) compared to 1.7° C. without the PEA.

FIG. 5 at “B” also shows the corresponding wind speed and solar global horizontal irradiance (GHI) measured during the stagnation temperature experiment.

During that 24-h period, the temperature of both devices closely tracked the ambient temperature and solar irradiance. However, the emitter with the PEA constantly maintained a much lower temperature than the uninsulated emitter due to the solar reflecting and thermally insulating nature of the PEA. Around solar noon (30-minute average around 13:22) at an average solar irradiance of 1123 W/m², a temperature difference with the ambient of ΔT=−13° C. was measured for the PEA device while the No PEA device only achieved ΔT=−1.7° C. Similarly, around midnight, the PEA device achieved ΔT=−18.3° C. while the No PEA device reached ΔT=−8.4° C. Moreover, the No PEA emitter temperature was more strongly influenced by wind than the PEA emitter (see temperature fluctuations in FIG. 5 at “A” and the corresponding wind speed variations in FIG. 5 at “B”), indicating the effectiveness of the PEA to reduce parasitic heat gain by adding an extra thermal resistance between the emitter and the ambient air. The combined high solar reflectance (modeled Rₛₒₗₐᵣ=0.944 for 12 mm thick PEA) and added conduction thermal resistance (˜t_{PEA}/k_{PEA}) of the PEA enabled significantly lower emitter stagnation temperatures during both the day and night compared to an uninsulated high-performance selective emitter.

A second set of experiments was performed to evaluate and compare the useful daytime cooling power at different PEA thicknesses.

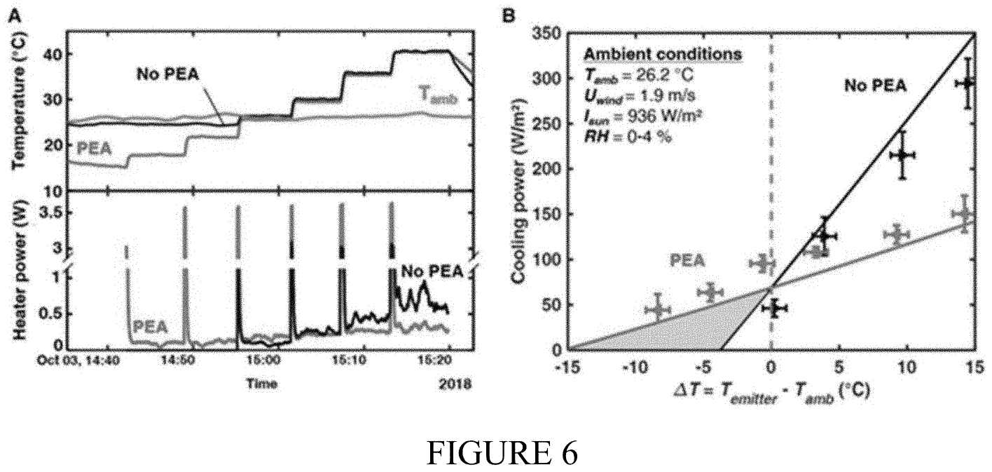

In one of these experiments (FIG. 6), two extreme cases are compared, an emitter covered with a thick (18 mm) layer of PEA (PEA) against an emitter without PEA (No PEA). FIG. 6, at “A”, shows measured emitter temperature of two devices (18 mm thick PEA and no PEA) as well as the corresponding heater power and ambient temperature during the cooling power experiment. FIG. 6 at “B” shows cooling power of the two devices as a function of the emitter sub-cooling in San Pedro de Atacama, Chile. The shaded area represents the range of cooling power and sub-ambient temperatures made accessible by the PEA compared to an uninsulated emitter.

In another similar experiment (FIG. 11), two intermediate thicknesses (6 mm PEA vs 12 mm PEA) are compared, demonstrating the variation in cooling performance with PEA thickness. As shown n FIG. 11, thicker PEA enables lower sub-ambient temperature and higher cooling power at sub-ambient temperatures. An intersection of the theoretical cooling power curves at ΔT=−4° C. is observed, highlighting the necessity to optimize the PEA thickness for a given operation temperature. In other words, operation at warmer emitter temperatures (ΔT>−4° C.) will be best with the thinner PEA while operation at colder temperatures (ΔT<−4° C.) will benefit from the thicker PEA. In fact, as the emitter temperature goes above the ambient, convective cooling starts dominating over radiative cooling, making the higher effective heat transfer coefficient h_{eff} of the device with thinner PEA beneficial.

The experiments were started by allowing the emitters to cool down to near steady-state conditions (see the PEA and No PEA emitter temperature in FIG. 6, at “A”). The temperature of the (main and guard) emitters was increased in a stepwise manner using the PID controlled heaters at their back side. At the same time, the heater power at both main emitters as well as the ambient conditions (ambient temperature and humidity, wind speed and solar irradiance) were measured. The experimental cooling power was then obtained by normalizing the heater power, averaged over 2 minutes, by the main emitter area at every temperature step. More details about the cooling power experiment and the measurement uncertainty are included in the “Methods” section below.

FIG. 6, at “B”, shows the theoretical (solid lines) and experimental (data points) emitter cooling power versus the emitter sub-cooling for the two devices (PEA and No PEA). The theoretical results were obtained using the model presented earlier and the atmospheric transmittance modeled based on the geographical location and the average weather conditions (see inset in FIG. 6, at “B”) during the time of the experiments [32]. Experimentally, the cooling power of the PEA device was 96±9 W/m² near the ambient temperature (ΔT=−0.6±0.8° C.) when the average solar irradiance was 936 W/m², compared to a cooling power of 46±10 W/m² (ΔT=0.2±0.8° C.) for the No PEA device. Similar to the stagnation temperature experiment, the device with PEA also enabled lower sub-ambient temperatures (maximum cooling up to ΔT=−15° C. compared to ΔT=−3.8° C. for the No PEA emitter according to the model) due to the added solar reflectance and thermal insulation. More specifically, by adding 18 mm of PEA on top of the emitter, h_{eff} was reduced from 12.9 W/m²K to 1.4 W/m²K while the cover provided an additional solar reflectance Rₛₒₗₐᵣ=0.948, based on the model. Overall, the experimental and theoretical results are in good agreement, demonstrating the potential of the model to predict the performance of a radiative cooler with PEA. Differences between the experimental and theoretical results can be explained by the uncertainty in the measurements, the fluctuations in the ambient conditions and the theoretical model approximations including assuming 1D heat transfer (infinitively large emitter and PEA) and the azimuthally symmetric radiative heat transfer which requires the solar irradiation to be normal to the emitter (see supplementary materials).

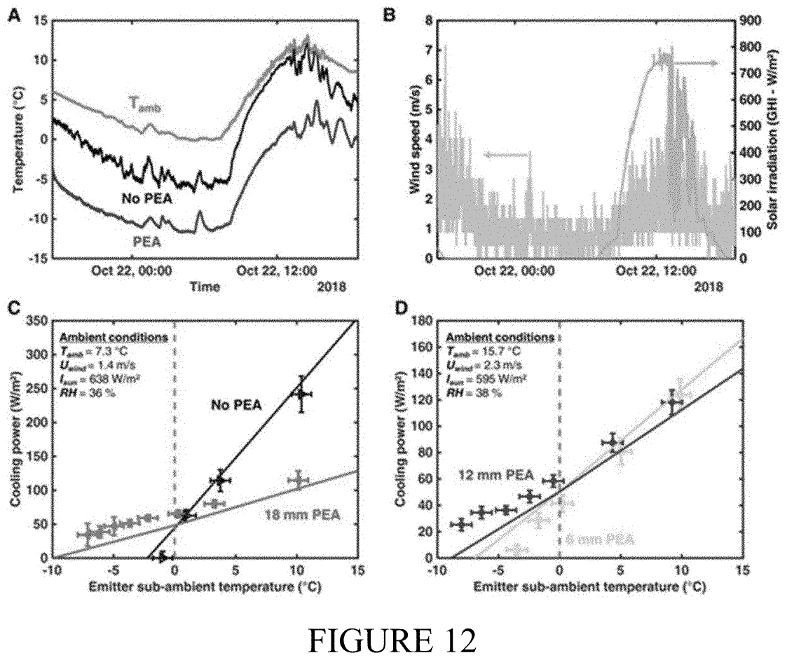

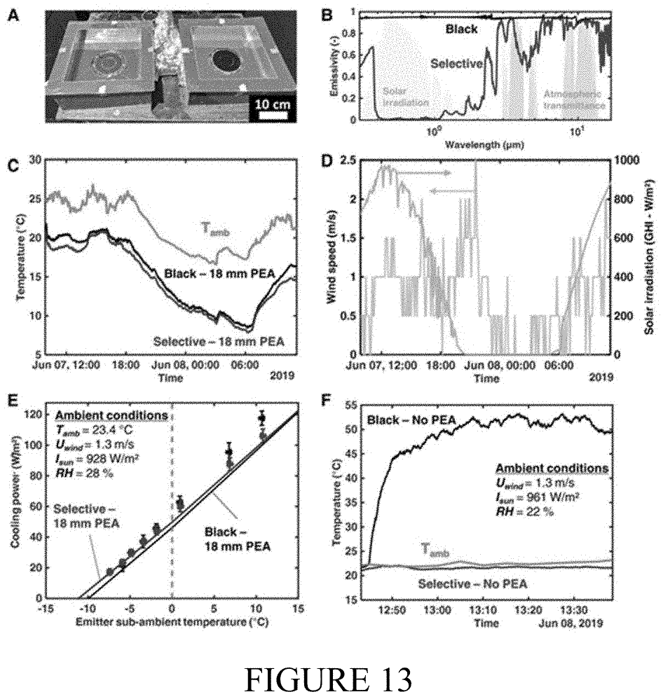

Additional experimental results are also presented below. In FIG. 11, also described above, the influence of PEA thickness (6 mm PEA vs 12 mm PEA) on the emitter cooling power is demonstrated. In FIG. 12, the radiative cooling performance (stagnation temperature and cooling power) in a more humid and colder environment (Cambridge, Mass.) is demonstrated. In FIG. 13, the influence of emitter solar reflectance (black vs selective emitter) on the radiative cooling performance (temperature and cooling power) when covered with 18 mm thick PEA is demonstrated. These results further show good agreement with the model in two different regions of the world while also suggesting that PEA significantly minimizes the importance of the emitter solar reflectivity, and that an optimal PEA thickness (i.e., maximizing cooling power) exists for a given sub-ambient temperature.

By using PEA for radiative cooling, higher sub-ambient cooling power and operation is achieved at much lower temperatures than with an uninsulated selective emitter, opening up a wide regime of operation (shaded area in FIG. 6, at “B”) that enables access to cooling powers and sub-ambient temperatures that were previously not accessible.

Optically selective and thermally insulating PEA cover can be used for high-performance sub-ambient radiative cooling. Adding PEA on top of a radiative cooling emitter provides a simple approach to reducing parasitic heat gain and solar absorption at the emitter, two limiting factors that have severely hindered the performance of previous experimental demonstrations. Using PEA and a commercially available selective emitter, a daytime cooling power of 96 W/m² at ambient temperature as well as cooling of up to 13° C. below ambient can be achieved, surpassing by more than 22% the performance of previous stagnation temperature experiments [19].

The performance of PEA also can be investigated using a robust theoretical model considering both conductive and radiative heat transfer. The model provides insights on the compromise between system performance and PEA thickness which allows determination of an optimal PEA thickness for any given system, weather conditions and operating temperature. Due to its high solar reflectance, PEA allows the use of non-selective emitters with no significant degradation in performance, possibly enabling simpler design and lower cost radiative coolers.

Advantageously, OSTI covers can be used for sub-ambient radiative cooling. Because the approach is modular and can readily be implemented in existing systems, the performance of existing radiative cooling systems can be improved, such as radiative cooling water panels for air conditioning units of buildings [16,19], sorption-based water harvesting devices [40] as well as passive refrigeration of food produce [41]. Alternative IR transparent materials such as BaF₂ and ZnS [18] also may achieve better optical and thermal performance. Theoretical models also can be expanded to optimize the cover thickness and optical properties for varying weather conditions (e.g., day to day variation over a year) as well as costs (e.g., incremental increase in performance versus incremental cost with thicker PEA).

Methods

Fabrication of Polyethylene Aerogels

0.5% wt. of ultra-high molecular weight polyethylene (429015, Sigma-Aldrich; polymer) was mixed with 99.3% wt. of paraffin oil (76235, Sigma-Aldrich; solvent) and 0.2% wt. of butylated hydroxytoluene (W218405, Sigma-Aldrich; antioxidant) in a sealed beaker at room temperature. The solution was then heated in a silicone oil bath at 150° C. and mixed using a magnetic stirrer. After complete dissolution of the polymer in the solvent (˜30 min), the homogeneous solution was poured in a preheated circular aluminum mold (13.5 cm diameter and 10 mm depth). The mold was then inserted in a water bath (5° C.), initiating the thermally induced phase separation and resulting in a polymer gel. Next, the paraffin oil was removed using a three-step solvent exchange in hexane. Another three-step solvent exchange in ethanol was performed to remove the hexane to ensure chemical compatibility with a critical point dryer. Finally, the gel was dried using the critical point dryer (Automegasamdri®-938, Tousimis) which replaced the ethanol from the PEA with air while preventing collapse of the porous structure. The initial polymer concentration was chosen to maximize solar reflectivity, infrared transmittance and structural integrity of the gel during fabrication, while the sample thickness was chosen as a compromise between number of samples needed for the experiments to achieve the desired thicknesses and fabrication time (i.e., solvent exchange and critical point drying are diffusion limited processes).

Density Measurement

The density of the PEA was calculated from its measured volume and mass. The reported density was determined from the average density of three samples and the uncertainty accounts for the accuracy of the measured mass and volume, as well as variation between samples.

Thermal Conductivity Measurement

A thermal conductivity setup based on the guarded-hot-plate method ASTM C1044-16 [39] was used to measure the thermal conductivity of the PEA. Similar to the emitter in the radiative cooling experiments, a main heater (7 cm diameter) and a surrounding guard heater (14 cm diameter) are used in this standard measurement. This design limits 2D heat transfer effects to the guard heater, allowing 1D heat transfer at the main heater which thus mimics a large sample where side effects are negligible. Only the main heater power and area are used in the characterization of the sample thermal conductivity. Polished copper was used as the boundary surface of the heater and cold plate to minimize radiative heat transfer between the two through the PEA, thus allowing measurement of the conductive and convective components of thermal conductivity of the porous material. Tests at four different temperature differences (2.5° C., 5° C., 10° C., 20° C.), all with an average temperature of 20° C., were performed and averaged. The reported uncertainty in the measured thermal conductivity accounts for the measurement accuracy of the sample thickness, temperature difference, heater surface area and heater power, as well as the variation between tests.

Optical Measurements

The optical transmittance and reflectance of the PEA and the emitter were measured using a UV-Vis-NIR spectrophotometer (Cary 4000, Agilent) and an FTIR spectrometer. Integrating spheres (Internal DRA-2500, Agilent and Mid-IR IntegratIR™, Pike Technologies, respectively) were used to account for the diffusely transmitted and reflected light.

Ambient Weather Measurement

A Campbell Scientific CS215 probe was used to measure the ambient temperature (accuracy of ±0.4° C. between 5° to 40° C.) and relative humidity (accuracy of ±4% between 0% to 100%). The wind speed was measured using an anemometer (034B, Met One) with an uncertainty of 0.1 m/s within the wind speed range of the experiment. The GHI solar irradiance was measured using a pyranometer (CMP6, Kipp & Zonen) with an uncertainty of ±2.3%. A rotating shadowband radiometer (RSR2, Campbell Scientific equipped with LI-200R, LI-COR photovoltaic pyranometer) was also used as a backup irradiance measurement system and was in excellent agreement with the pyranometer. Instruments were connected to a datalogger (CR1000, Campbell Scientific). Weather data was sampled every three seconds and averaged every minute.

Stagnation Temperature Measurement

The temperature of the emitters was measured using T-type thermocouples (TT-T-40-SLE-25, Omega) installed at their backside (center of the main and guard) and connected to a DAQ module (USB-TC, Measurement Computing). The DAQ was enclosed in a reflective aluminum box to minimize temperature gradients between the thermocouple junctions and the DAQ cold junction sensors. The thermocouples were calibrated before the experiments in an ethylene glycol solution using a chiller (A25, Thermo Scientific) and a resistance temperature detector (RTD) (P-M-A-1/4-3-1/2-PS-12, Omega) which resulted in an uncertainty of ±0.3° C. The data acquisition was done using LabVIEW.

Cooling Power Measurement

The temperature of the emitters was controlled using heaters (main and guard, like the guarded-hot-plate thermal conductivity setup) at their backside that were regulated using a PID control. Each main heater was connected to a power supply (2425, Keithley and 2440, Keithley) in a 4-wire configuration to allow accurate measurement of the heating power at the emitter only. A triple channel power supply (2230-30-1, Keithley) was also used to power the guard heaters in a 2-wire configuration. The data acquisition and PID control were accomplished using LabVIEW. The main heater power and emitter temperature were averaged for two minutes after the initial transient peak in heater power. The uncertainty of the emitter temperature was determined from the thermocouple and ambient temperature sensor accuracy as well as their fluctuations during the averaging period (two-minute average after stabilization of the emitter temperature). The cooling power uncertainty was determined after accounting for the accuracy of the main emitter area measurement and of the power supplies, the main heater power fluctuations during the averaging period as well as the small parasitic lateral heat transfer between the main and guard emitters. Specifically, an indoor measurement was performed to characterize the lateral heat transfer coefficient between the main and guard emitters and found it to be 24.5 W/m²K, meaning that for every degree in temperature difference, an effective change in cooling power of 24.5 W/m² was observed at the main emitter. This effect was however only found to be important near the stagnation temperature of the devices. In fact, due to higher parasitic heat gain and low cooling power close to the stagnation temperature, the guard temperature was higher than the main emitter, causing heat transfer between the two emitters and giving rise to additional 2-D parasitic heat gains at the main emitter. Since all other data points and the model assume 1-D heat transfer at the main emitter, the cooling power data point at the stagnation temperature of both devices was removed.

Influence of Emitter Solar Reflectivity and Effective Heat Transfer Coefficient

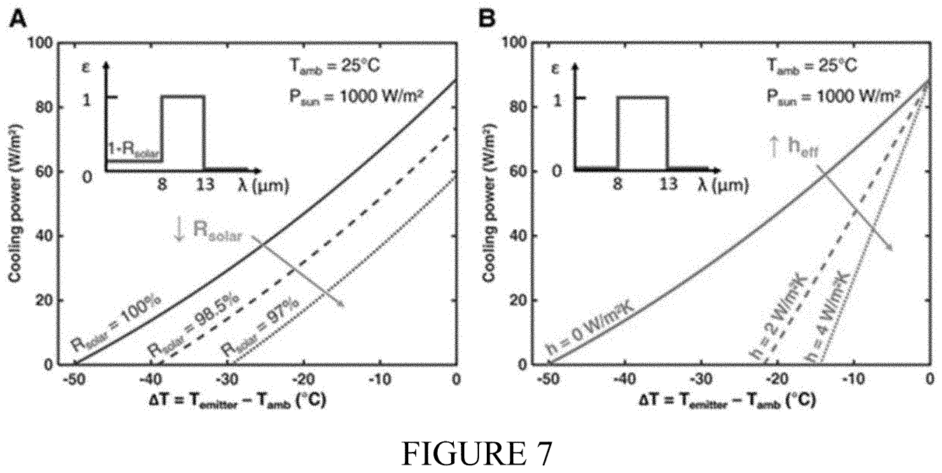

FIG. 7, at “A”, shows the influence of the emitter solar reflectivity Rₛₒₗₐᵣ on the cooling power of a selective emitter. Because solar irradiance (Iₛᵤₙ˜1000 W/m²) is an order of magnitude larger than the radiative cooling power at ambient temperature (P_{cool}˜100 W/m²), any solar absorption (αₛₒₗₐᵣ=1−Rₛₒₗₐᵣ) at the emitter will represent a significant decrease in cooling power (e.g., αₛₒₗₐᵣ=0.01 decreases P_{cool} by 10 W/m² or ˜10%). Similarly, FIG. 7, at “B”, shows the influence of the effective heat transfer coefficient h_{eff} between the ambient and the emitter on its cooling power. While very low temperatures are possible when the emitter is perfectly insulated from its environment (h_{eff}=0 W/m²K), a small increase in h_{eff} severely decreases the maximum emitter sub-cooling and sub-ambient cooling power (P_{parasitic}=h_{eff}(T_{amb}−Tₑₘᵢₜₜₑᵣ)). While novel high-performance selective emitters can typically reach Rₛₒₗₐᵣ=0.97, although at the expense of complexity and practicality, and h_{eff} values close to 2.5 W/m²K [5, 19] have been achieved outside of a vacuum chamber, daytime radiative cooling performance under direct sunlight has remained severely limited by these non-idealities.

Theoretical Model for Emitter Cooling Power

To solve for the total cooling power P_{cool} of the emitter in contact with a thermally conducting and radiatively participating medium, the 1-D steady-state heat transfer equation (HTE) within the PEA was solved:

$$- {k}_{PEA} \frac{{d}^{2} T}{{dx}^{2}} + \frac{{dq}_{r}}{dx} = 0 , \qquad ( S1 )$$

where k_{PEA} is the PEA thermal conductivity, x is the spatial coordinate along the thickness of the PEA, T is the spatial temperature profile in the medium and qᵣ is the spatial radiative heat flux. The HTE is satisfied when the radiative and conductive terms cancel each other, i.e. steady state equilibrium temperature profile T(x) in the medium has been determined. To obtain this equilibrium temperature profile, T(x) was initially guessed, calculated the radiative and conductive terms, and then updated T(x) based on the difference between the radiative and conductive terms. Once the equilibrium T(x) has been determined, the correct radiative and conductive heat fluxes may be calculated at any x in the medium. P_{cool} is thus calculated by summing the radiative (qᵣ) and conductive (q_{cond}=−k_{PEA}dT/dx) heat fluxes at the PEA/emitter interface (x=t_{PEA}),

P_{cool}=qᵣ(x=t_{PEA})+q_{cond}(x=t_{PEA}), (S2)

which represents the total heat flow at that interface and therefore at the emitter. The conductive heat flux at this same interface also allow us to estimate the effective heat transfer coefficient

$${h}_{eff} = \frac{{q}_{cond} ( x = {t}_{PEA} )}{( {T}_{emitter} - {T}_{amb} )} , \qquad ( S2 )$$

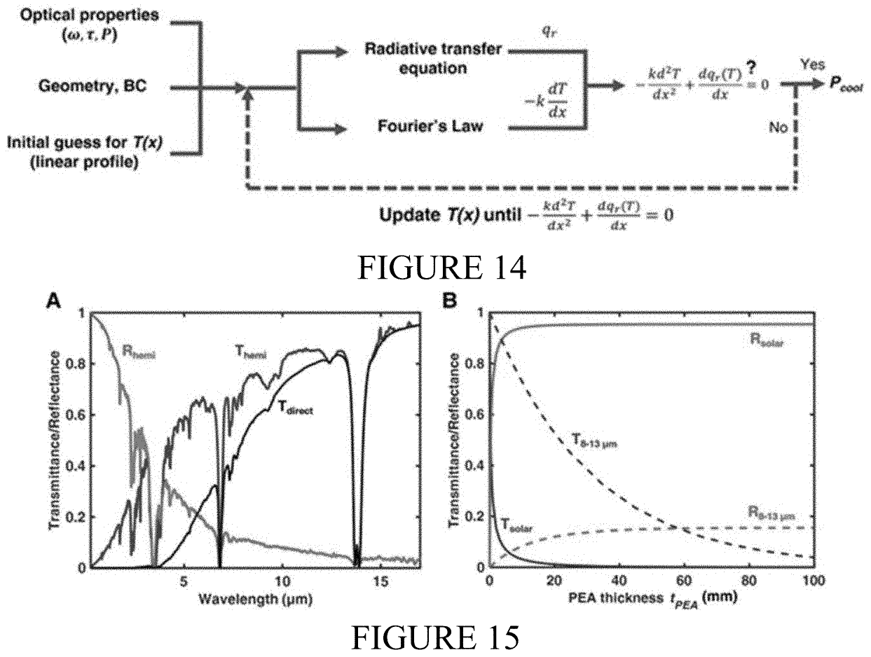

between the emitter and the ambient in the presence of PEA. More details about the iterative process are shown in FIG. 14. (More particularly, FIG. 14 shows the iterative process for cooling power modeling. Iterative process for solving for the cooling power P_{cool} at the emitter for combined radiative and conductive heat transfer in the PEA).

More specifically, the model starts by discretizing the PEA medium into L layers of equal thickness and by assuming a linear temperature profile within it based on the set boundary conditions. A convection coefficient h_{conv} with the ambient is assumed at the top of the medium while the temperature at the bottom is fixed as the emitter temperature Tₑₘᵢₜₜₑᵣ. Solving for Fourier's law within the medium calculates the conductive heat flux at each of the L layers. The convection coefficient was estimated using the experimentally measured average wind speed V and from an empirical equation h_{conv}=5.7+3.8V[42] for forced convection over a flat plate. A similar approach was used in other work [19] to estimate the convective heat transfer at the emitter due to forced convection with the ambient air.

The total radiative heat flux qᵣ is then separately calculated by solving for the radiative transfer equation (RTE). The RTE allows to model the radiative transport through the radiatively participating medium by considering absorption, emission and multiple scattering within the medium based on its optical properties (scattering albedo ω, extinction coefficient β and scattering phase function p), temperature profile and boundary conditions. The azimuthally symmetric 1-D spectral RTE with thermal emission and incident beam source can be written as

$$μ \frac{{dI}_{λ} ( {τ}_{λ} , μ )}{d {τ}_{λ}} = {I}_{λ} ( {τ}_{λ} , μ ) - \frac{{\overline{ω}}_{λ}}{2} {\int }_{- 1}^{1} d {μ}^{′} {p}_{λ} ( μ , {μ}^{′} ) {I}_{λ} ( {τ}_{λ} , μ ) - ( 1 - {\overline{ω}}_{λ} ) {B}_{λ} [ T ( {τ}_{λ} ) ] - \frac{{\overline{ω}}_{λ}}{4 π} {F}_{λ}^{s} {p}_{λ} ( μ , {μ}^{′} ) , \qquad ( S3 )$$

where λ is the wavelength, I_{λ} is the diffuse spectral radiance along direction μ=cos(θ) at an optical depth τ_{λ}=β_{λ}x, θ is the polar angle with respect to the zenith, β_{λ} is the spectral blackbody intensity at a temperature T and optical depth τ_{λ}, and F_{λ}^{s} is the spectral direct beam source (i.e., direct solar irradiation).

The beam source is assumed to be perpendicular to the medium boundary, which allows simplification of the model by assuming azimuthal symmetry. To account for the incident atmospheric radiance as well as emission and reflection at the emitter, the following boundary conditions can be used:

$$\begin{matrix}{I}_{λ} ( {τ}_{λ} = 0 , - μ ) = {I}_{∞ , λ} ( - μ ) , & ( S4 ) \\ {I}_{λ} ( {τ}_{λ} = {τ}_{λ , total} , + μ ) = {ɛ}_{λ} {B}_{λ} ( {T}_{emitter} ) + \frac{{F}_{λ}^{s}}{π} {e}^{- {τ}_{λ , total}} ( 1 - {ɛ}_{λ} ) + 2 {\int }_{0}^{1} d {μ}^{′} {μ}^{′} ( 1 - {ɛ}_{λ} ) {I}_{λ} ( {τ}_{λ , total} , - μ ) , & ( S 5 )\end{matrix}$$

where I_{∞,λ} is spectral diffuse radiance at the top of the medium (i.e., the atmospheric radiance), ε_{λ} is the emitter emissivity, Tₑₘᵢₜₜₑᵣ is the emitter temperature and τ_{λ,total} is the spectral total optical depth of the medium. The atmospheric transmittance and radiance, as well as the solar spectrum were evaluated with MODTRAN®6.0 [32] using the experimental weather conditions (location, time, temperature and humidity).

Using the boundary conditions listed above, the spectral RTE can be solved for by using the discrete ordinate method [37], which provides a quick and accurate solution of the diffuse spectral intensity field within the medium I_{λ}. The net radiative flux qᵣ at any location x in the medium can then be calculated from the spectral diffuse intensity field and direct component of radiation.

qᵣ(x)=2π∫₀^{∞}∫₁⁻¹I_{λ}(τ_{λ},μ)μdμdλ+∫₀^{∞}F_{λ}^{s}e^{-τ}^{_{λ}}dλ, (s6)

The HTE can be solved using the iterative process shown in FIG. 14, which allows evaluation of the steady-state temperature profile T(x) within the PEA as well as the corresponding spatial distribution of the radiative and conductive heat fluxes within the medium. P_{cool} and h_{eff} can then be calculated from the radiative and conductive heat fluxes at the PEA/emitter boundary.

Optical Properties of PEA

As per the theoretical model description, solving the RTE uses the spectral optical properties (scattering albedo ω, extinction coefficient β and scattering phase function p) of the medium. These properties were therefore determined experimentally based on a previously validated method [38] in order to obtain accurate values for the fabricated PEA samples. The method is based on the fact that a unique set of optical properties exists (ω, β and p) for a given set of transmittances (hemispherical and direct) and reflectance (hemispherical) of a sample of known thickness. By measuring the transmittance, reflectance and thickness of a PEA sample, it is therefore possible to evaluate its thickness-independent optical properties which in turn can be used to model the transmittance and reflectance of similar samples with different thicknesses. The scattering phase function p can be expressed as a function of a single parameter g, known as the Henyey-Greenstein scattering phase function [37],

$${p}_{HG} ( cos Θ ) = \frac{1 - {g}^{2}}{{( 1 + {g}^{2} - 2 g cos Θ )}^{3 \text{/} 2}} , \qquad ( S7 )$$

where Θ is the scattering angle. In FIG. 15, the measured transmittances and reflectance are shown (see FIG. 15 at “A”) as well as the thickness dependent hemispherical transmittance and reflectance of PEA in the solar and mid-infrared (8-13 μm) spectrum calculated using the PEA optical properties (see FIG. 15 at “B”).

Thermal conductivity of polyethylene aerogels was studied. Polyethylene aerogels have recently been investigated in the literature as a potential solar reflecting and infrared transparent thermally insulating covers for radiative cooling. While increasing the thickness of the aerogel helps increasing the thermal resistance of the material, it also detrimentally effects its infrared transmittance, limiting the maximum aerogel thickness to a few millimeters. In this work, as an alternative approach, the work described herein seeks to better understand and quantify the heat transfer mechanisms in PEAs to propose pathways to reduce their thermal conductivity. PEA samples of densities were fabricated ranging from 12 kg/m³ to 82.2 kg/m³ and measured their thermal conductivity using a guard-hot-plate thermal conductivity setup, with pressures ranging from vacuum to atmospheric, with three gases (nitrogen, argon and carbon dioxide) and with low and high emissivity boundaries. The experimental results and modeling work indicate that gaseous conduction and radiative transfer in the case of high emissivity boundaries dominate heat transfer through the material. It was found that reducing the pore size and gas pressure, using lower thermal conductivity gases, adding infrared opacifiers and maintaining low density could all provide significant reduction in thermal conductivity.

This section describes experimental characterization of polyethylene aerogels thermal conductivity, a model coupling radiative transfer and conduction agrees with experimental results, thermal conductivity dominated by gas conduction and radiative transfer, mechanisms to reduce polyethylene aerogel thermal conductivity are proposed, and indications that more insulating aerogels can improve performance of radiative cooling systems.

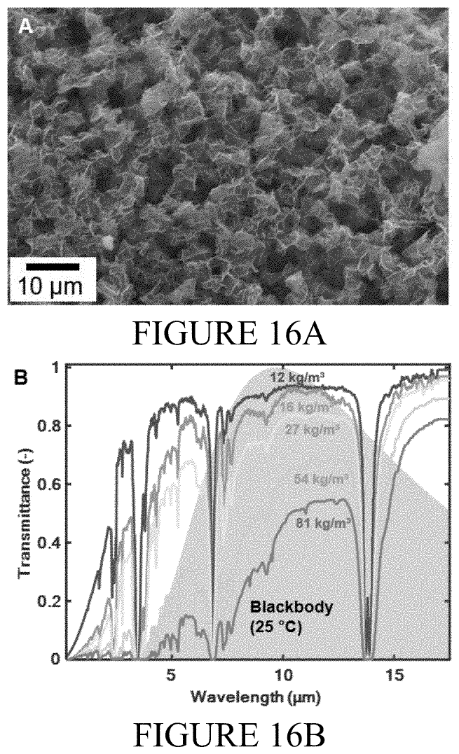

Polyethylene aerogels [43-47] (PEAs) are low density, high porosity and porous materials (open cell or closed cell) made of polyethylene and characterized by pore diameters around 2-5 μm (see FIG. 16A). The aerogel can have a density of between 10 kg/m³ to 100 kg/m³. The closed cell aerogel can be filled with air or other low thermal conductivity gases. The porous structure causes strong scattering of light in the solar spectrum, giving rise to PEAs' characteristic high solar reflectance and white look. In the infrared, PEAs are however semi-transparent due to the low absorption by the polyethylene backbone and weaker scattering. Owing to its low density, its thermal conductivity (radiative transfer aside) can typically approaches that of air (˜0.03 W/mK) [46, 47], making it a good thermal insulator.

The unusual combination of optical (solar reflecting and infrared transparent) and thermal properties of PEA has made it a promising material candidate in applications such as radiative cooling [45-47]. By covering the thermal emitter with a thick (>5 mm) layer of PEA, parasitic heat gains form the ambient air and incoming sunlight are minimized while still enabling rejection of infrared radiation to outer space by the emitter. The limited infrared transmittance of PEA, critical to ensuring efficient infrared rejection to outer space by the emitter, has however limited the maximum practical thickness and thus the total thermal resistance of the cover. Instead, reducing the thermal conductivity of PEA covers could offer an alternative approach to increasing the cover's thermal resistance while maintaining the high infrared transmittance characteristic of thinner PEA samples and thus enable better performing sub-ambient radiative cooling.

In this work, the components of thermal conductivity in PEA were studied to identify pathways for reducing the thermal conductivity of PEA. Experimental measurements of the thermal conductivity of PEA at densities ranging from 12-82 kg/m³, under low and high emissivity boundaries and with three different gases (argon, nitrogen and carbon dioxide) at pressures ranging from vacuum to atmospheric pressure are reported. The experimental results are compared to theoretical models accounting for the solid, gaseous and radiative transfer within the material. The results demonstrate that the thermal conductivity of PEA is dominated by gaseous conduction and radiation transfer with high emissivity boundaries, and that reducing the pore size in PEA, adding opacifiers and evacuating samples or filling with alternative gases such as argon and carbon dioxide could drastically improve the thermal resistance of PEAs. This work can enable higher sub-ambient cooling powers in radiative cooling as well as better performance thermal insulation in other applications.

Thermal Modelling

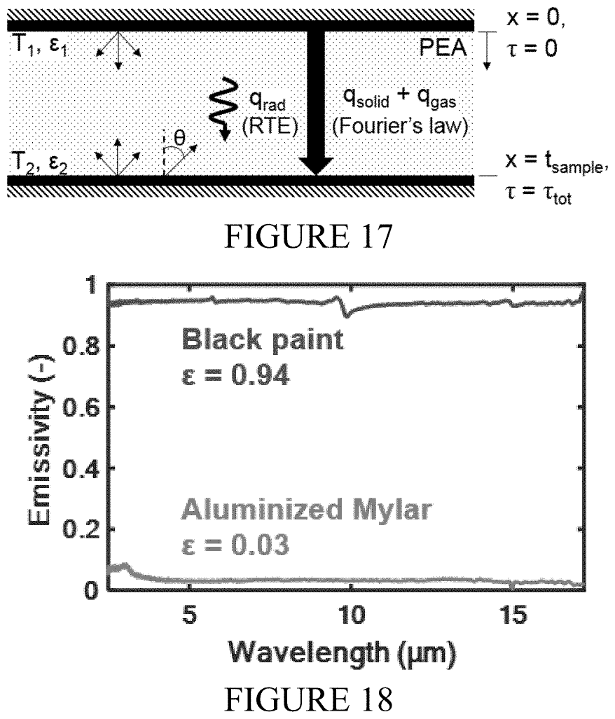

Thermal transport in PEA can be decomposed in three components, solid conduction through the polyethylene backbone, gaseous conduction within the pores and radiative transfer through the PEA. Convection within the PEA pores O(1-10 μm) [46, 47] is neglected due to dominant viscous forces over gravitational forces (small Rayleigh number) and is in line with previous work that demonstrated negligible convection in open-cell pores of diameter <O(1 mm) [48, 49]. In this section, modeling framework to account for heat transfer through the PEA by coupled radiative transfer and conduction within the gas and solid phases (see FIG. 17) is presented.

Solid Conduction

Many different approaches to model solid conductivity within aerogel and foam materials have been proposed in the past literature and a good review of past models is presented in [50]. While some models consist in empirical models relating the material's density to solid conductivity [51], many rely on an equivalent circuit method [52-55] based on periodic arrays of intersecting spheres or rods with square or cylindrical cross-sections. More work has also explored the influence of size effects using finite element analysis and molecular dynamics simulations [56] as well as the influence of interfacial resistance in interconnected nanoparticles forming the backbone of the aerogel by exploring phonon scattering mechanisms [57]. In this work, the heat transfer through the solid backbone by using the Glicksman model [53] which has proven to accurately model the thermal conductivity of polymeric foams in prior work [49, 58-60] has been simplified. The model assumes that the material is made of gas-filled, in-line cubic cells made of constant thickness walls and struts connecting the walls, that heat flows only through four of the faces and struts of the cubic cell and that the gas is locally at the same temperature as the cell walls. According to this model, the solid conductivity can be expressed by:

$${k}_{s} = {k}_{PE} ( 1 - ϕ ) ( \frac{2}{3} - \frac{{f}_{s}}{3} ) , \qquad ( 1 )$$

where k_{PE} is the thermal conductivity of the polyethylene backbone, φ is the solid fraction and fₛ is the mass fraction of struts in the cubic cell. In this work, k_{PE}=0.53 W/mK was assumed based on prior work in the literature characterizing the crystallinity [43] of polyethylene in PEA and the thermal conductivity of polyethylene at different crystallinities [61], as well as fₛ=1 based on prior literature results for low density polymeric porous materials [59, 62]. The solid fraction is calculated from the PEA density (ρ_{PEA}):

ϕ=1−ρ_{PEA}/ρ_{PE} (2)

Gaseous Conduction

According to the kinetic theory, the thermal conductivity of gases should be independent of density at a fixed temperature due to cancelling out of the change in mean free path between gas molecule collisions and change in density. However, when constrained to a volume with a characteristic length smaller than the mean free path of the gas molecules, the latter now instead predominantly collide with the container walls, resulting in a gaseous thermal conductivity proportional to the number of gas molecules. In porous materials such as PEA, gas conduction in the pores O(1-10 μm) can thus be strongly suppressed by decreasing the gas pressure. According to Kaganer's model [63], the pressure dependent gaseous thermal conductivity k_{g} in a pore of diameter D can be estimated by:

$${k}_{g} = \frac{{k}_{g 0}}{1 + 2 β Kn} , \qquad ( 3 )$$

where k_{g0} is the free space gas thermal conductivity, β is a coefficient depending on the accommodation α and adiabatic γ coefficients of the gas and Kn is the Knudsen number defined as the ratio of the gas mean free path l_{g} and the PEA pore diameter D. The gas mean free path is given by:

$${l}_{g} = \frac{{k}_{B} T}{\sqrt{2} π {d}_{g} P} , \qquad ( 4 )$$

where k_{b} is the Boltzmann constant, T is the gas temperature, d_{g} is the gas molecule diameter and P is the gas pressure. In this work, three gases are investigated: nitrogen, argon and carbon dioxide. The properties used for these gases are presented in Table 1. Other models building up on Kaganer's model have also been proposed such as Zeng's model [64] which modifies the gas mean free path to account for collision with the motionless particles forming the backbone as well as models accounting for the distribution of pore sizes [65, 66] within the aerogel. While these models can give better accuracy in modeling gas conduction in a porous sample, they require knowledge of additional parameters such as the sample's specific surface area, specific heat or pore size distribution, which makes them more difficult to apply. Coupling [67, 68] between the solid and gaseous conductivities is also neglected in this work which will later be proven to be a reasonable assumption.

TABLE 1
Properties of gases investigated in this work at T = 20°
C. and P = 101.325 kPa. k_{g0} is the thermal conductivity of the gas,
d_{g} the gas molecule diameter, α the accommodation coefficient,
γ the adiabatic coefficient of the gas, β the gas dependent factor [68, 69].

| | k_{g0} | d_{g} | α | γ | β |
|---|---|---|---|---|---|
| Gas | (W/mK) | (Å) | (−) | (−) | (−) |
| Nitrogen (N) | 0.0255 | 3.2 | 1 | 1.40 | 1.55 |
| Argon (Ar) | 0.0175 | 3.6 | 1 | 1.67 | 1.84 |
| Carbon dioxide (CO₂) | 0.0162 | 4.6 | 1 | 1.29 | 1.42 |

Radiative Transfer

To model radiative transfer in porous and aerogel materials, past work has relied on various model ranging in complexities and assumptions. Simpler models represented the porous structure as a series of parallel opaque planes [70] or assumed an optically thick medium (Rosseland diffusion approximation [51, 71]) while more robust models accounted for absorption and emission of radiation by solving for the radiative transfer equation (RTE) in scattering [72] and non-scattering medium [73]. Due to the low yet non-zero absorption and scattering of infrared radiation in PEA (semi-transparent medium), a detailed account of emission, absorption and scattering within the medium should be done to properly model radiative transfer through the material. This is further accentuated by the wide range of optical depths that is encountered between thin and low density samples, and thick and high density samples as well as the different optical boundary conditions (low or high emissivity) that are tested experimentally. In this work, the RTE was used to solve for the diffuse intensity of unpolarized light and thus radiative heat flux within a stationary medium of constant refractive index that experiences absorption, emission and scattering as a function of its temperature, optical properties (scattering albedo ω, extinction coefficient β and scattering phase function p), and boundary conditions. The azimuthally symmetric 1-D spectral RTE with thermal emission is given by:

$$μ \frac{{dI}_{λ} ( {τ}_{λ} , μ )}{d {τ}_{λ}} = {I}_{λ} ( {τ}_{λ} , μ ) - \frac{{ω}_{λ}}{2} {\int }_{- 1}^{1} d {μ}^{′} {p}_{λ} ( μ , {μ}^{′} ) {I}_{λ} ( {τ}_{λ} , μ ) - ( 1 - {ω}_{λ} ) {B}_{λ} [ T ( {τ}_{λ} ) ] , \qquad ( 5 )$$

where λ is the wavelength of light, I_{λ} is the diffuse spectral radiance along direction μ=cos(θ) at an optical depth τ_{λ}=β_{λ}x where x is the sample's depth, θ is the polar angle (see FIG. 17) and B_{λ} is the spectral blackbody intensity at a temperature T and optical depth τ_{λ}. In the model, the PEA sample is subject to the following boundary conditions:

I_{λ}(0,−μ)=ϵ_{1,λ}B_{λ}(T₁)+2∫₀¹dμ′μ′(1−ϵ_{1,λ})I_{λ}(0,μ), (6)

I_{λ}(τ_{λ,tot}),μ)=ϵ_{2,λ}B_{λ}(T₂)+2∫₀¹dμ′μ′(1−ϵ_{2,λ})I_{λ}(τ_{λ,tot},−μ), (7)

where εᵢ is the boundary emissivity, Tᵢ is the boundary temperature and i represents the boundary index as per FIG. 17.

The RTE was solved in MATLAB using the discrete ordinate method [74] which transforms the RTE into a linear set of differential equations by discretizing the angular domain in 2N streams. The optical properties (ω, β and p) of the medium are derived from experimental measurements of the PEA samples, as detailed in past work [46, 75]. In this work, the number of streams was set to N=12 and account for the wavelength-dependent optical properties by dividing the spectrum into 191 spectral bands. Furthermore, the medium was divided into L=20 layers to account for the spatially varying temperature profile and thus blackbody intensity (B_{λ}) within PEA. Finally, the radiative heat flux is calculated by integrating the spectral diffuse intensity over all wavelengths and angles:

qᵣ(x)=2π∫₀^{∞}∫₁⁻¹I_{λ}(τ_{λ}(x),μ)μdμdλ (8)

Total Thermal Conductivity

As radiative and conductive heat transfer are independent processes and do not vary equally with temperature, it is necessary to account for their interaction and solve for the combined radiative and conductive (solid+gas) heat transfer in semi-transparent media such as PEAs. Radiative and conductive heat transfer was coupled across the PEA by solving the heat equation [76]:

$$\frac{d}{dx} ( - ( {k}_{s} + {k}_{g} ) \frac{dT}{dx} + {q}_{r} ) = 0 \qquad ( 9 )$$

The heat equation is solved iteratively by varying the temperature profile in the PEA, similarly to past work [46, 72], until convergence of the divergence of the radiative and conductive (solid+gaseous) heat fluxes. The total thermal conductivity kₜₒₜ of the sample can then be calculated by:

$${k}_{tot} = \frac{( - ( {k}_{s} + {k}_{g} ) \frac{dT ( x = 0 )}{dx} + {q}_{r} ( x = 0 ) )}{{T}_{1} - {T}_{2}} {t}_{sample} \qquad ( 10 )$$

And the radiative component of thermal conductivity k, is therefore given by:

kᵣ=kₜₒₜ−kₛ−k_{g} (11)

Material and Methods

PEA samples were fabricated with densities ranging from 12 kg/m³ to 82.2 kg/m³ to measure their thermal conductivity. The samples were prepared by mixing in a beaker ultra-high molecular weight polyethylene powder (429015, Sigma-Aldrich) with butylated hydroxytoluene antioxidant (W218405, Sigma-Aldrich) and paraffin oil solvent (76235, Sigma-Aldrich). The mass percentage of polyethylene powder in the solution was chosen as 0.35%,0.5%,1%,2.5% and 5% to obtain the different density samples. The solution was heated in an oil bath at 160° C. with a magnetic stirrer for 30 minutes to obtain a homogenous solution. The solution was then poured in a 13.5 cm diameter and 10 mm deep aluminum mold that was immediately submerged in a water bath to cool the solution and initiate phase separation of the polyethylene from the paraffin oil. After three solvent exchanges in hexane and then ethanol, the samples were dried in a CO₂ supercritical point dryer (Automegasamdri®-938, Tousimis). The fabricated PEA samples are summarized in Table 2.

TABLE 2
Fabricated samples for experimental characterization.

| Sample | Density | Thickness | Boundary |
|---|---|---|---|
| # | (kg/m³) | (mm) | condition |
| 1 | 12.0 | | Black paint |
| 2 | 15.6 | 5.7 | Black paint |
| 3 | 24.3 | 8.9 | Black paint |
| 4 | 52.6 | 7.5 | Black paint |
| 5 | 81.0 | 8.3 | Black paint |
| 6 | 12.0 | 4.1 | Aluminized Mylar |
| 7 | 15.6 | 5.8 | Aluminized Mylar |
| 8 | 26.7 | 8.1 | Aluminized Mylar |
| 9 | 54.2 | 7.3 | Aluminized Mylar |
| 10 | 82.2 | 8.1 | Aluminized Mylar |

The samples' thermal conductivity was measured using a custom-built guarded-hot-plate thermal conductivity setup operated in the single-sided mode based on the ASTM C1044-16 standard practice [77]. The setup was equipped with a 65 mm diameter metering thin-film heater surrounded by a 140 mm diameter guard thin-film heater. The heaters were sandwiched between 3.18 mm thick copper plates. A water-cooled aluminum cold plate was used for the cold-side temperature boundary. The surfaces of the cold plate and heaters were painted with commercially available black paint or covered with aluminized mylar to provide high and low emissivity boundaries respectively (see FIG. 18). Thermocouples (type K) embedded within the heaters' copper plate and the cold plate measured their temperature. The temperature difference between the hot and cold plates, and between the metering and guard heaters, was measured by a three and single junction pairs thermopile respectively. All experiments were performed with a temperature difference of 20° C. with T₁=12° C. and T₂=32° C. The metering heater was connected to a power supply (2425; Keithley) in a four-wire configuration while the guard heaters were connected in a two-wire configuration to another power supply (2230-30-1; Keithley).

The guarded-hot-plate thermal conductivity setup was installed inside a 0.3×0.3×0.3 m vacuum chamber to enable measurements from vacuum to ambient pressure in various gases. Three gases were connected to the chamber, nitrogen (NI UHP300; Airgas), argon (AR UHP300; Airgas) and carbon dioxide (CD BD300S; Airgas). Gas pressure inside the chamber was measured using pressures sensors (Pirani gauge and Omega). All data acquisition and control of the heaters was done using a custom-made LabVIEW program.

Influence of Gas Type and Pressure

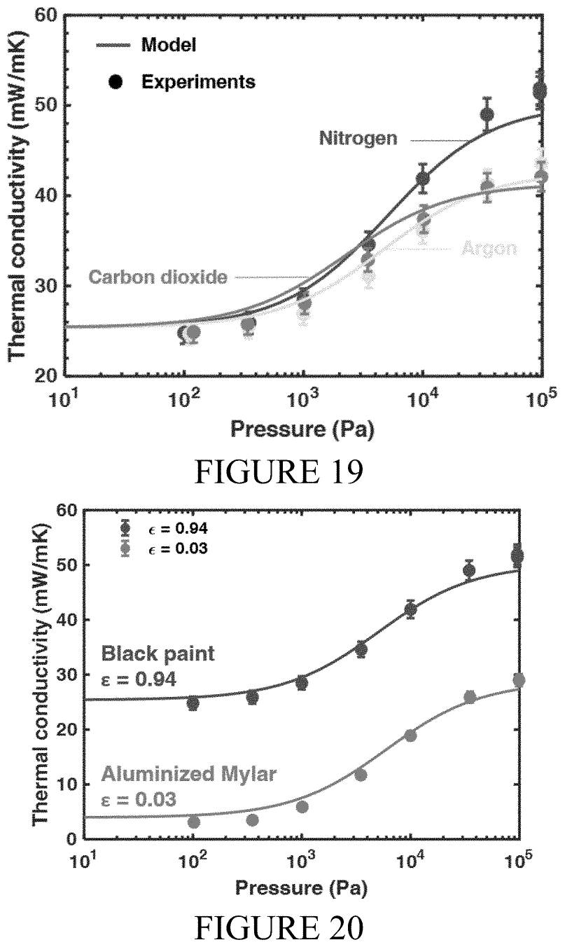

Using the guarded-hot-plate thermal conductivity setup equipped with high emissivity boundaries, the gas type and gas pressure dependent thermal conductivity of a low density (15.6 kg/m³) PEA sample (sample #2) was measured. The experimental and theoretical results are depicted in FIG. 19 and show good agreement. The sample's effective pore diameter is estimated at 5.6 μm by fitting [78] the experimental gaseous thermal conductivity in nitrogen to the model. At low gas pressures, measurements in all three gases converge towards the same value of 0.025 W/mK, representing heat flow through the solid polyethylene backbone and by radiative transfer only. With increasing gas pressure, as expected, a general upward trend in thermal conductivity as the mean free path of the gas molecules becomes smaller than the pore diameter. The relative increase in thermal conductivity with pressure however varies with different gases due to the different gas particle diameter d_{g} which as per Eq. 3 and 4 tends to shift the typical S-shape curve of gaseous thermal conductivity towards higher pressures for smaller d_{g} and vice versa. At ambient pressure, the sample's thermal conductivity significantly depends on the gas type inside its porous structure and a reduction of around 0.010 W/mK (˜20%) can be achieved by replacing nitrogen with lower thermal conductivity gases such as argon and carbon dioxide. While significant reduction in thermal conductivity is possible by decreasing the gas pressure, the results show that a pressure <10³ Pa is required to suppress most of the gaseous conduction. Overall, significant reduction in thermal conductivity is possible by filling the PEA pores with lower thermal conductivity gases or by reducing the gas pressure has been shown.

Influence of Boundary Conditions

Since PEAs are mostly transparent in the mid-infrared (see FIG. 16B), their thermal conductivity can be expected to strongly vary with boundary emissivity. Furthermore, for materials such as PEA covers in radiative cooling, it is important to decouple the solid and gaseous components of thermal conductivity from the radiative component since the application typically requires materials with low solid and gaseous conductivity but high infrared transmittance (i.e., high radiative thermal conductivity). As such, one can experimentally and theoretically compare in FIG. 20 the thermal conductivity of low density (˜15 kg/m³) PEA samples in nitrogen sandwiched between high (black paint) and low (aluminized Mylar) emissivity boundaries. In vacuum, the sample's thermal conductivity with low emissivity boundaries, equal to 0.0031 W/mK, is dominated by conduction through the solid polyethylene backbone and negligible radiative transfer through the weakly absorbing/emitting material. On the other hand, as one switches to high emissivity boundaries, a drastic increase in thermal conductivity in vacuum is seen, stemming from the increased radiative transfer between the boundaries through the semi-transparent material. The gas pressure dependence of thermal conductivity exhibits a similar behavior for both boundary properties. The results show that for applications requiring only low solid and gaseous thermal conductivity, heat transfer through the material can be almost completely suppressed by reducing the gas pressure to below 10³ Pa. For other applications requiring low radiative conductivity as well (i.e., typical thermal insulation), the results suggest that the addition of infrared opacifiers to make PEAs opaque in the infrared could provide a way to reduce the total thermal conductivity. Overall, the semi-transparent characteristic of PEA makes the material's thermal conductivity highly dependent on the boundary conditions and careful consideration should thus be taken when referring to its thermal conductivity depending on the application (e.g., infrared transparent thermally insulative cover in radiative cooling or typical insulation).

Influence of PEA Density

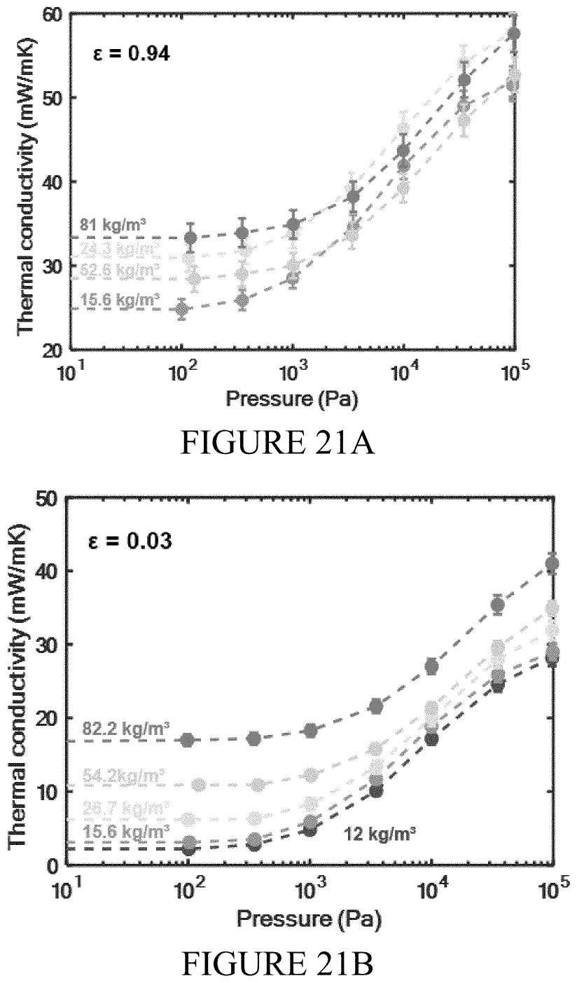

Next, the influence of density on the total thermal conductivity of PEA in nitrogen under high (FIG. 21A) and low (FIG. 21B) emissivity boundaries was investigated. One can notice from the crossover of the typical S-curves in FIG. 21A that a slight shift of the thermal conductivity towards higher gas pressures is observed with denser samples, suggesting smaller pore sizes. In general, higher density samples tend to have higher thermal conductivity due in part to an increase in solid conduction through the polyethylene backbone. While the effect of density on thermal conductivity is clear for the low emissivity boundaries measurements FIG. 21B, a more complex behavior is observed for the high emissivity boundaries measurements FIG. 21A. In fact, the competing effect of decreasing radiative transfer and increase solid conduction through PEA with higher densities coupled with the differences in sample thickness make the analysis in FIG. 21A more challenging without further investigation. In the next section, the modeling work is used to decouple and quantify the different components of the experimentally determined thermal conductivities to better understand the contribution of each components and give insights on how to improve the thermal performance of PEA.

Decomposing the Components of Thermal Conductivity

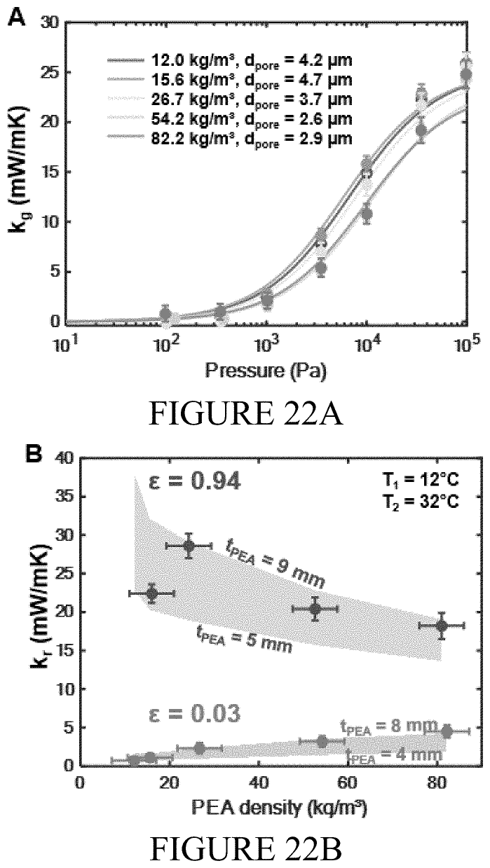

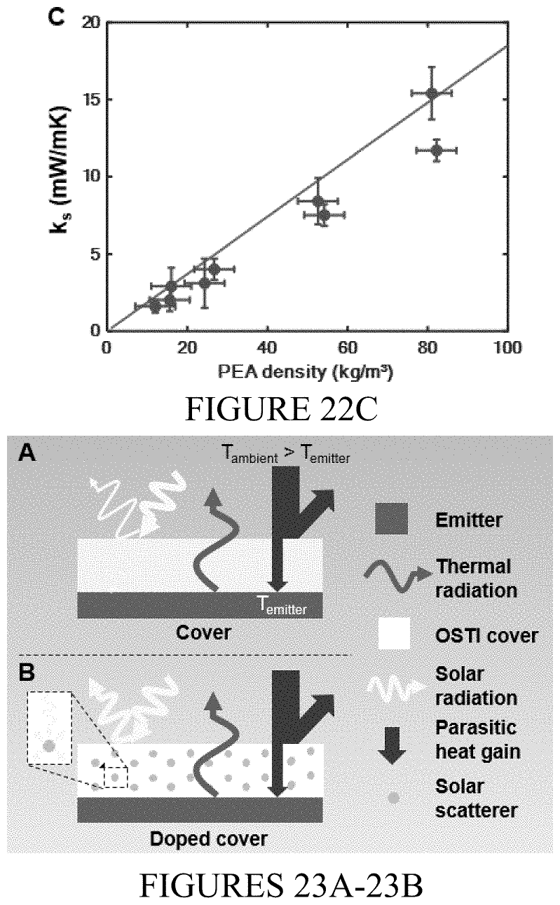

Using the modeling framework, in FIGS. 22A-22C, all three components of thermal conductivity are quantified from experimental measurements of thermal conductivity and optical properties of the PEA samples.

In FIG. 22A, the pressure dependent gaseous component of thermal conductivity k_{g} for PEA samples measured with low emissivity boundaries is shown. k_{g} is calculated by subtracting the total thermal conductivity kₜₒₜ from the vacuum thermal conductivity kₜₒₜ (P=10⁻³ Pa) and the pore diameter is estimated by fitting the model to the data, similar to FIG. 19. Higher density samples show smaller pore sizes, as was predicted from the right-shifted S-curves of thermal conductivity. The pore sizes match that observed in prior work [47].

Next, a radiative transfer model was used to estimate the radiative component of thermal conductivity kᵣ given the sample's thickness and optical properties, and the boundary conditions. The results are plotted in FIG. 22B for the two different boundary conditions and for the range of sample thicknesses, showing a higher k, for high emissivity boundaries than for low emissivity boundaries due to radiative transfer between boundaries through the semi-transparent PEA. Different trends are however observed within the range of densities for the low and high emissivity boundaries. For the high emissivity case, a decrease of kᵣ with density is observed due to decreasing infrared transmittance of the PEA, which inhibits radiative transfer between the two boundaries. For the low emissivity case, the boundaries are almost perfect reflectors and therefore do not contribute much to kᵣ. But as the PEA density is increased, the sample becomes more and more absorbing and thus emitting in the infrared, therefore increasing the radiative transfer between different locations at different temperatures within the sample. kᵣ also depends on the boundary temperatures and sample thickness (as represented by the area in FIG. 22B), and that kᵣ would fall to zero if one increased the optical depth of the sample to infinity.

Finally, the solid component of thermal conductivity kₛ by subtracting kᵣ from the total thermal conductivity in vacuum kₜₒₜ(P=10⁻³ Pa) was calculated. The modeled and experimental kₛ values for different densities are shown in FIG. 22C, showing a relatively good agreement. As expected, the solid conductivity increases with density, but remains relatively low (≤0.005 W/mK) for densities smaller than 30 kg/m³.

Overall, decomposing the total thermal conductivity into its three components revealed that at ambient conditions, gaseous conduction and radiative transfer typically dominate heat transfer through PEA, while solid conduction generally contributes negligibly at low densities.

The data and model also give insights on how one can improve the thermal conductivity of PEA. First, one can notice from the gaseous conduction in FIG. 22A that pores inside PEA are too large to provide any significant reduction in gaseous thermal conductivity at ambient pressure. Making PEA with smaller pores could help reduce the most important contributor to the material's thermal conductivity by shifting the typical S-curve to the right, as has been explored with other type of aerogels [51]. Second, replacing nitrogen (or air) with a lower thermal conductivity or smaller molecular diameter gas could also reduce the gaseous component of thermal conductivity, up to around 36% for carbon dioxide at ambient pressure. Third, reducing the gas pressure inside PEA by sealing it could completely eliminate gaseous conductivity. Sealing the aerogel for long periods of time, ensuring the mechanical stability of PEA under one atmosphere of pressure or using infrared transparent sealants (required for radiative cooling applications) may however pose a challenge. Fourth, for applications other than radiative cooling, the radiative component of thermal conductivity k, can significantly be reduced by using opacifiers, as has been done with other aerogels. Finally, solid conduction can be kept small (≤0.005 W/mK) by maintaining the PEA density below 30 kg/m³.

In summary, the thermal conductivity of PEAs was studied and characterized, deepening the understanding about the heat transfer mechanisms in the material and guiding the future design of lower thermal conductivity PEAs. First is presented a theoretical framework, which decomposed the total thermal conductivity into solid, gaseous and radiative components. The radiative transfer equation, accounting for absorption, emission and scattering in PEA, was solved for to model radiative transfer in the material. Conductive and radiative heat transport was then coupled using the heat equation to account for both interacting phenomena in semi-transparent PEA and for the range of boundary conditions tested. The thermal conductivity of twelve PEA samples of varying densities (12-82.2 kg/m³) in three different gases (nitrogen, argon and carbon dioxide) was then experimentally characterized at pressures ranging from vacuum (10⁻³ Pa) to atmospheric pressure (10⁵ Pa) using a custom-built guarded-hot-plate thermal conductivity setup. Using the experimental results and modeling work, one can estimate the contribution of each components of thermal conductivity to the samples' total thermal conductivity, highlighting the importance of gaseous conduction and radiative transfer under high emissivity boundaries. The results were used to suggests future approaches to decrease the thermal conductivity of PEAs, such as decreasing the pore size, using lower thermal conductivity gases, decreasing the gas pressure, adding infrared opacifiers and using lower density samples. This work contributes to improving the performance of PEA covers in radiative cooling as well as in other applications requiring low thermal conductivity materials.

This section describes investigations of ZnS pigmented polyethylene aerogel covers for daytime radiative cooling. Optically selective and thermally insulating (OSTI) covers such as polyethylene aerogels (PEAs) have recently been proposed for sub-ambient radiative cooling. By minimizing parasitic solar absorption and heat gain at the emitter, OSTI covers allow for lower stagnation temperatures and higher sub-ambient cooling powers. In this work, the addition of zinc sulfide (ZnS) nanoparticles inside PEAs was investigated to improve their optical selectivity. Solving for multiple scattering effects using the radiative transfer equation and Mie theory, the optical properties of PEA covers with different ZnS concentrations and particle diameters have been modeled. These theoretical results, along with experimental characterization of PEA covers with commercially available ZnS nanoparticles (SACHTOLITH HD-S), show that the addition of ZnS particles inside PEAs can significantly improve their optical selectivity by reducing solar transmittance while maintaining high infrared transmittance. Using energy balance models, it was demonstrated that the ZnS pigmented PEA covers enable higher sub-ambient cooling powers and lower stagnation temperatures than conventional PEA under direct solar radiation. Finally, the optimal spatial distribution of ZnS within the cover was investigated and showed that confining the ZnS near the air-PEA boundary could reduce the total ZnS mass required and achieve a higher cooling power. The simple addition of solar scattering particles such as ZnS to PEA covers could improve their performance and enable their application for passive cooling of buildings and refrigeration of food produce.

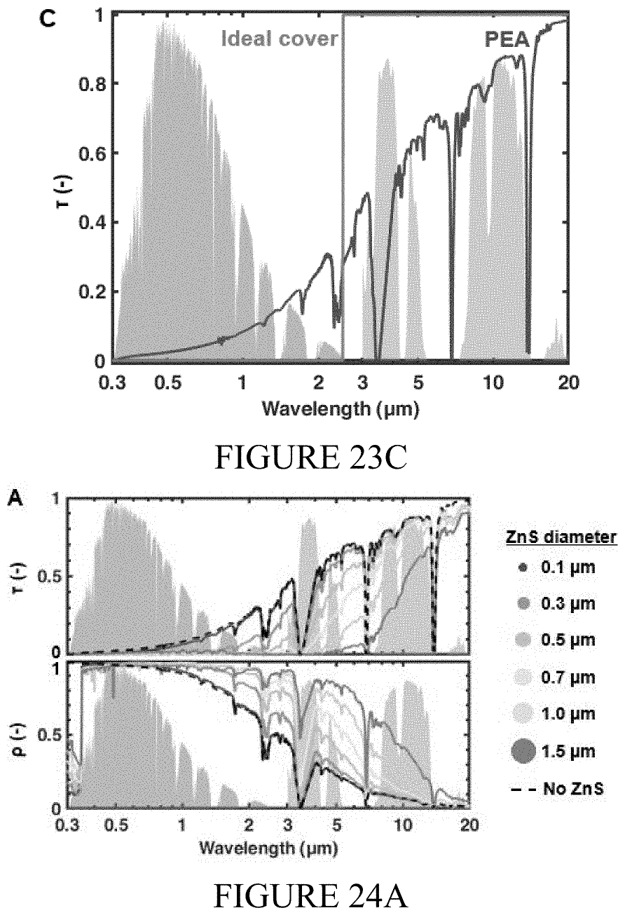

Radiative cooling is the process by which terrestrial objects reject infrared (IR) radiation to outer space through the transparent spectral window (8-13 μm) of the atmosphere, referred to as the atmospheric window. In the absence of sunlight and for a perfectly insulated system, passive radiative cooling can achieve a cooling power over 100 W/m² at ambient temperature and minimum temperatures around 50° C. below ambient temperature. However, under direct sunlight during the day, parasitic solar absorption and heat gain from the warmer ambient air significantly reduce the performance of the radiative cooler, limiting the practically realizable sub-ambient cooling to less than 13° C. [79-93]. To address these challenges, optically selective and thermally insulating (OSTI) covers such as polyethylene aerogel (PEA) which can thermally insulate the cold emitter from the warmer ambient air while selectively reflecting sunlight and transmitting IR radiation were recently proposed [91, 94] (FIG. 23A). By covering an emitter with such a cover, previous work has experimentally [91] and theoretically [95, 96] demonstrated that better cooling performance was possible at sub-ambient temperatures compared to uncovered emitters.

The development of an OSTI cover involves optimization of competing optical and thermal properties—solar transmittance (Tₛₒₗₐᵣ) and reflectance (Rₛₒₗₐᵣ), IR transmittance (τ_{IR}) and thermal conductivity of the cover material (k_{PEA}). Optically, an ideal cover should have Tₛₒₗₐᵣ=0 (Rₛₒₗₐᵣ=1) (FIGS. 23A-23C) to minimize solar absorption at the emitter and within the OSTI cover, and τ_{IR}=1 to maximize IR rejection from the emitter to outer space. Experimentally achieving such optical selectivity is however challenging and limited by the porous structure and fabrication process of PEA. As the thickness (or density) of PEA samples is increased beyond a few millimeters, both, the solar and IR transmittance decrease (at different rates) due to increasing scattering in of light by the porous structure in the solar spectrum and non-zero absorption of polyethylene in the infrared (see FIG. 7) respectively. PEA samples with relatively low density (˜15 kg/m³) were used in past work to achieve Tₛₒₗₐᵣ=0.06 (Rₛₒₗₐᵣ=0.92) and τ_{IR}=0.80 at a thickness of 6 mm. Significantly better optical properties—approaching that of an ideal cover—are likely possible, and could yield significant gains in cooling performance while lowering cost by reducing the required OSTI cover thickness and allowing the use of low-cost non-selective scalable emitters. Past work have investigated varying the scattering size and geometry [89, 97-99], adding organic/inorganic micro/nano inclusions [100, 110] or using hierarchically microstructures [99, 101] to improve the optical selectivity of porous polymeric materials. However, these approaches have not been demonstrated for PEA.

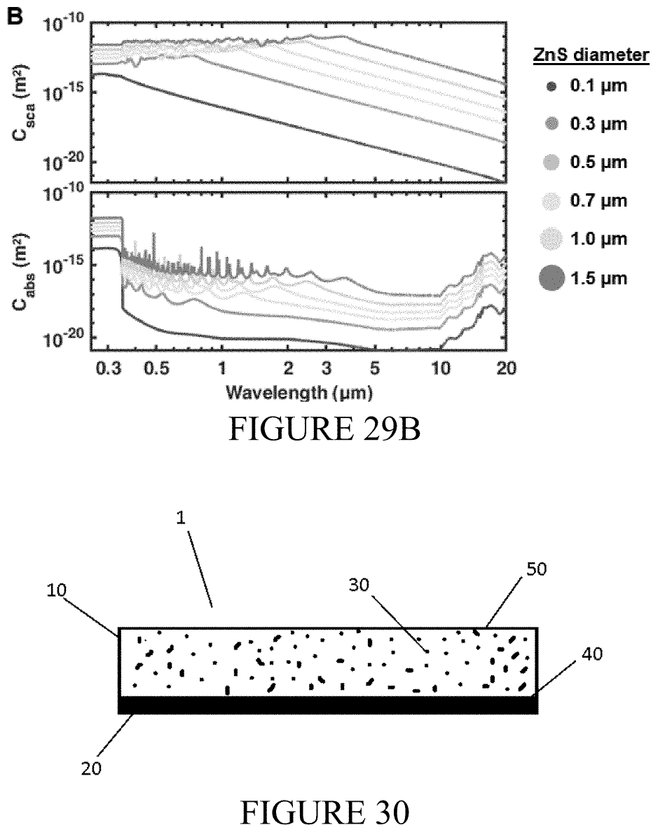

In this work, the potential of using highly optically-selective PEA containing ZnS solar scattering nanoparticles for daytime radiative cooling has been demonstrated (FIG. 23B). Our work builds on past work [90, 102-105] that has demonstrated the use of ZnS, ZnO, ZnSe and TiO₂ nanoparticles to decrease solar transmittance (while maintaining high IR transmittance) of clear polyethylene films. Semiconducting ZnS nanoparticles were chosen (bandgap at 3.54 eV) with relatively high real refractive index [106] in the solar spectrum (n=2.29 at 1 μm) and low imaginary refractive index at infrared wavelengths (k=6×10⁻⁶ at 10 μm), making it an ideal material candidate for a solar scattering and infrared transparent material (see FIGS. 29A-29B). The effect of ZnS concentration and particle size on the optical properties of PEA+ZnS covers by using the radiative transfer equation (RTE) and Mie theory was first theoretically investigated. PEA samples were then fabricated with different concentrations of commercially available ZnS nanoparticles (SACHTOLITH HD-S) and experimentally measured their optical properties—showing good agreement with our theoretical model. Next, the influence of ZnS on the cooling performance of radiative coolers under direct sunlight was investigated—demonstrating up to 58 W/m² higher cooling power with a ZnS pigmented PEA cover combined with a blackbody emitter compared to an unpigmented PEA cover. Finally, the effect of ZnS spatial distribution within the OSTI cover was analyzed—indicating that a higher ZnS concentration near the ambient air interface can result in higher cooling power while using less ZnS.

Modeling Optical Properties of ZnS Doped OSTI Cover

The modeling approach first uses the RTE [107, 108] (Eq. 1) to solve for the spectral transmittance and reflectance of the OSTI covers based on the material's optical properties. Radiative transport is then coupled with heat conduction within the cover using the heat equation to estimate the cooling power of an emitter shielded with an OSTI cover.

By accounting for the optical properties (scattering albedo ω, extinction coefficient β and scattering phase function p), temperature profile and boundary conditions of a stationary medium of constant refractive index, the RTE allows calculation of the diffuse unpolarized light intensity at any location within the medium. The azimuthally symmetric 1-D spectral RTE with thermal emission and incident beam source can be written as

$$μ \frac{{dI}_{λ} ( {τ}_{λ} , μ )}{d {τ}_{λ}} = {I}_{λ} ( {τ}_{λ} , μ ) - \frac{{ω}_{λ}}{2} {\int }_{- 1}^{1} d {μ}^{′} {p}_{λ} ( μ , {μ}^{′} ) {I}_{λ} ( {τ}_{λ} , μ ) - ( 1 - {ω}_{λ} ) {B}_{λ} [ T ( {τ}_{λ} ) ] - \frac{{ω}_{λ}}{4 π} {F}_{λ}^{s} {p}_{λ} ( μ , {μ}^{′} ) , \qquad ( 1 )$$

where λ is the wavelength, I_{λ} is the diffuse spectral radiance along the direction μ=cos(θ) and at an optical depth τ_{λ}=β_{λ}x, θ is the polar angle with respect to the zenith, B_{λ} is the spectral blackbody intensity at a temperature T and optical depth τ_{λ}, and F_{λ}^{S} is the spectral direct beam source (i.e., unit beam source for calculating the transmittance or reflectance, or direct solar irradiation when calculating the radiative cooling power of an emitter). The beam source is assumed to be perpendicular to the medium boundary, which allows azimuthal symmetry and simplifies the model.

Solving the RTE (Eq. 1) requires knowledge of the optical properties (ω, β and p) of all components of the medium (PEA and ZnS). By assuming independent scattering from the ZnS nanoparticles and PEA, the contributions of both constituents to evaluate the medium's total optical properties can be summarized [108]. Similar to previous work [91, 109], and based on the Henyey-Greenstein [107] approximation (which uses a single asymmetry factor g to represent the angular dependent scattering phase function p), the PEA ω, β and p were evaluated using experimental measurements of hemispherical transmittance and reflectance, and direct transmittance of an unpigmented PEA sample. To evaluate the ZnS nanoparticle optical properties (ω, β and p), the Mie theory [108, 110] was used, assuming independent scattering by spherical particles of known size, refractive index and concentration. The ZnS nanoparticles have a uniform size distribution, are located on the surface of the polyethylene porous structure (i.e., not embedded inside the polyethylene lamellae) such that they are surrounded by air only and that scattering of light by individual ZnS nanoparticles is not affected by the PEA backbone as well as by other surrounding ZnS nanoparticles (i.e., independent scattering). While the latter assumptions might not hold for smaller particles (≤0.1 μm) and in the mid-IR regime (where scattering is small compared to the solar spectrum), they are adopted for simplicity. (FIGS. 29A-29B show the spectral absorption and scattering cross-section of ZnS particles of different diameters at a concentration of 15 kg/m³ (same density as PEA) for reference). The total optical properties of the OSTI cover by adding [108] has been estimate the individual contributions of the PEA and ZnS nanoparticles assuming independent scattering:

$$\begin{matrix}{σ}_{sca , λ} = {C}_{sca , λ , PEA} {N}_{t , PEA} + {C}_{sca , λ , ZnS} {N}_{t , ZnS} , & ( 2 ) \\ {σ}_{abs , λ} = {C}_{abs , λ , PEA} {N}_{t , PEA} + {C}_{abs , λ , ZnS} {N}_{t , ZnS} , & ( 3 ) \\ {β}_{λ} = {σ}_{sca , λ} + {σ}_{abs , λ} , & ( 4 ) \\ {g}_{λ} = \frac{{g}_{λ , PEA} {C}_{sca , λ , PEA} {N}_{t , PEA} + {g}_{λ , ZnS} {C}_{sca , λ , ZnS} {N}_{t , ZnS}}{{σ}_{sca , λ}} , & ( 5 )\end{matrix}$$

where σ_{sca,λ} and σ_{abs,λ} are the spectral scattering and absorption coefficients (m⁻¹), C_{sca,λ} and C_{sca,λ} are the spectral scattering and absorption cross-sections (m²), Nₜ is the number of particles per unit volume (m⁻³) and g is the asymmetry factor of the Henyey-Greenstein phase function approximation.

Knowing the optical properties of the OSTI cover, the RTE was solved using the discrete ordinate method [107, 111] which discretizes the angular domain into discrete intervals and thus transforms the integro-differential equation (Eq. 1) into a linear set of differential equations that are easier to solve. Once the diffuse light intensity is calculated, the intensity of light was integrated over the full hemisphere at both ends of the medium (in a direction normal to the medium) to calculate the diffuse transmittance and reflectance. The hemispherical transmittance is calculated by summing up the diffuse and direct (unattenuated) components while the hemispherical reflectance is assumed equal to the diffuse component.

The cooling power of an emitter shielded by an OSTI cover by solving the steady state heat equation within the cover was estimated, as described in ref. [91]. An iterative solver is used to solve the heat equation by varying the temperature profile within the medium to achieve convergence of the divergence of radiative and conductive heat fluxes. Once the temperature profile is determined, the radiative and conductive heat fluxes was added inside the cover at the emitter to get the cooling power.

Improving the Optical Selectivity of PEA Covers Using ZnS

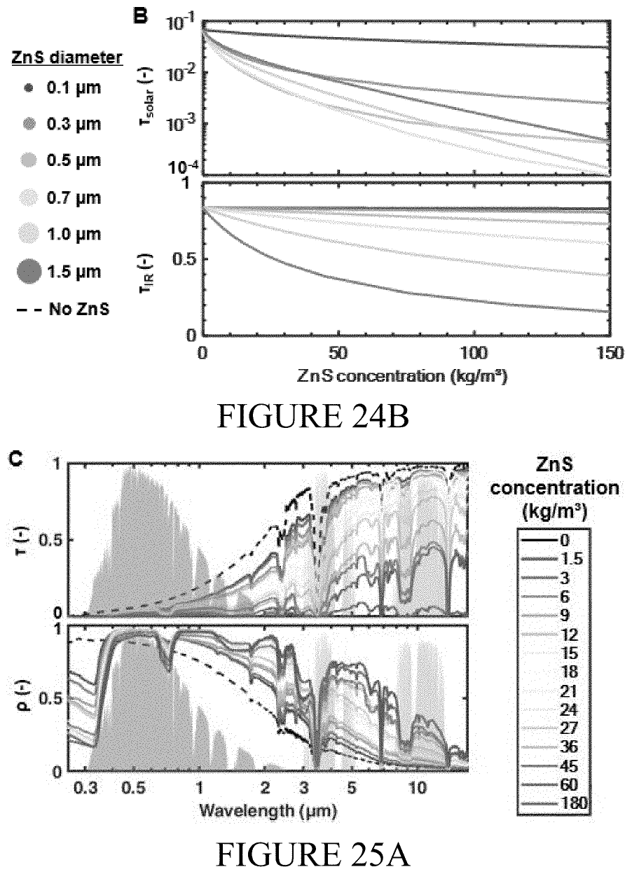

FIG. 24A shows the theoretical hemispherical transmittance (τ, top) and reflectance (ρ, bottom) of PEA with ZnS nanoparticles as well as the normalized solar spectrum and sky transmittance (U.S. Standard 1976 [112]). Results are shown for PEA pigmented with different ZnS diameters (0.1 to 1.5 μm) at a fixed ZnS concentration, C_{ZnS}=30 kg/m³, along with an unpigmented PEA sample (black dashed line in FIG. 24A). Larger ZnS particles increase scattering at longer wavelengths, resulting in lower transmittance and higher reflectance across all wavelengths considered. At C_{ZnS}=30 kg/m³, solar transmittance is mostly suppressed for particle diameters ≥0.3 μm, while IR (8-13 μm) transmittance remains relatively constant for particle diameters ≤1 μm, suggesting an ideal particle diameter within that range to maximize optical selectivity of the cover. FIG. 24B shows the weighted solar (τₛₒₗₐᵣ, top) and IR (τ_{IR}, bottom) transmittance for the different ZnS particle diameters as a function of ZnS concentration. It was observed that for particle diameters ≥0.3 μm, even relatively low ZnS concentrations (˜20 kg/m³) can significantly reduce τₛₒₗₐᵣ from 0.069 to less than 0.01. On the other hand, very little change in IR transmittance τ_{IR} (τ_{IR}>0.80) is observed as one increases ZnS concentration, except for larger ZnS diameters (≥1 μm). Overall, the theoretical results show that improved optical selectivity can be achieved by doping existing PEA covers with appropriate ZnS concentration and particle diameter.

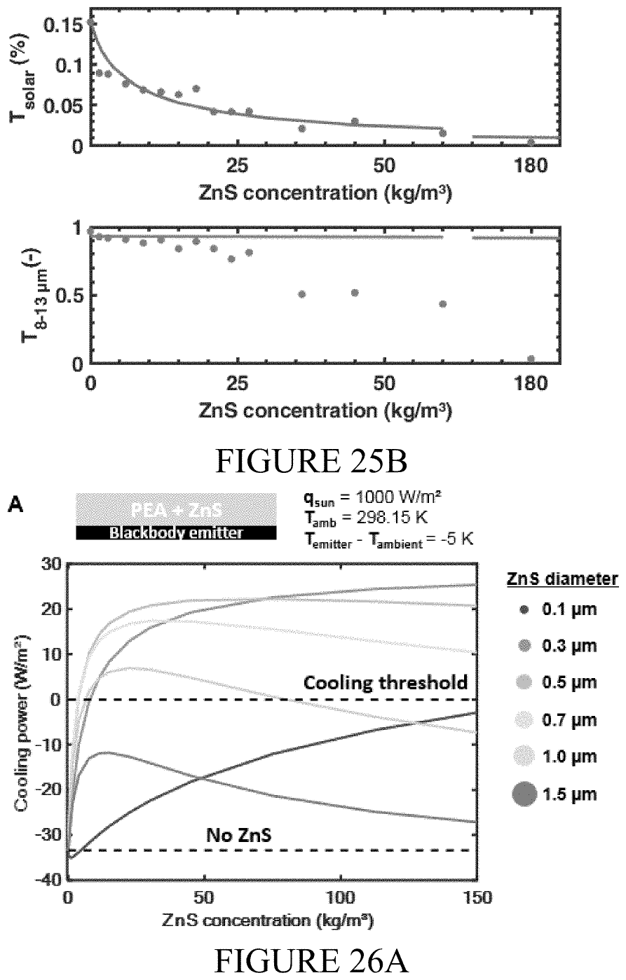

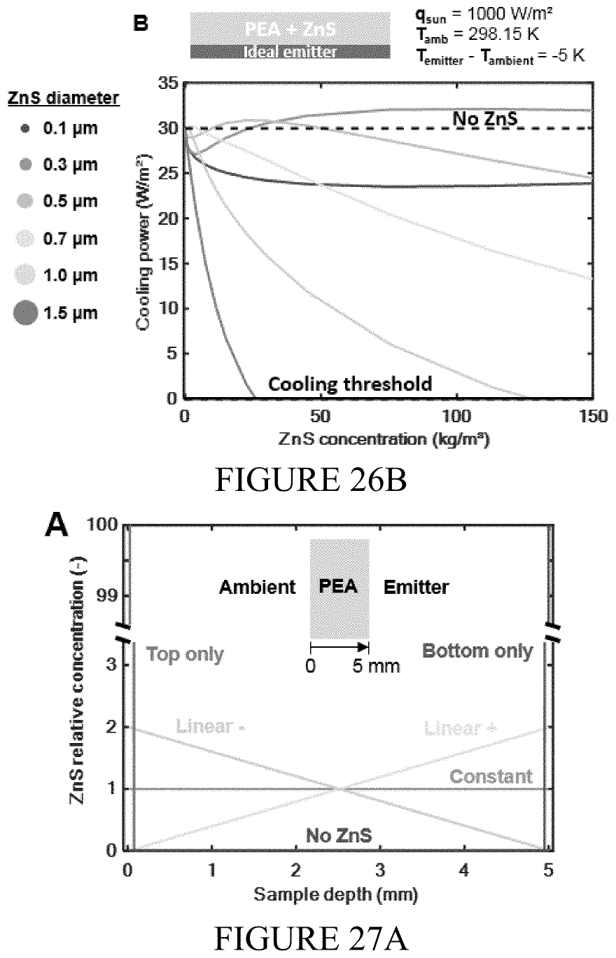

To experimentally demonstrate the improved optical selectivity, 2 mm thick PEA samples (PEA-only density of 15 kg/m³) doped with various concentrations (1.5-180 kg/m³) of commercially available ZnS powder (SACHTOLITH HD-S; >97% pure ZnS of particle diameter 0.3 μm) were fabricated using a fabrication process similar to that used in previous work [91]. Different ZnS concentrations in the PEA were achieved by mixing ZnS nanoparticles with polyethylene powder prior to sample preparation. The samples' optical properties (hemispherical transmittance and reflectance) were measured using a UV-VIS spectrophotometer and Fourier Transform Infrared (FTIR) spectroscopy, each equipped with an integrating sphere. Results plotted in FIGS. 26A and 26B show similar trends to theoretical results—improved optical selectivity with large decrease in τₛₒₗₐᵣ can be achieved with ZnS doping in PEA for a range of concentrations. However, additional absorption peaks, between 8-9.5 μm, and stronger scattering in the IR are observed in our experimental spectra compared to the theoretical spectra. The presence of contaminants [113] such as BaSO₄ (<3 wt. %) or ZnO (0.2 wt. %) within the commercial ZnS powder can incur additional scattering and absorption within the material. In fact, BaSO₄ has a strong absorption peak [114] between 8-9.5 μm, which matches the additional absorption peak observed in experimental measurements. Furthermore, possible aggregation of ZnS particles in the fabricated samples could also have increased scattering at longer wavelengths. The solar (τₛₒₗₐᵣ) and IR (τ_{IR}) weighted transmittance are also plotted in FIG. 25B along with our theoretical model. Even a small concentration (1.5-25 kg/m³) of ZnS can drastically decrease S rv from 0.15 to less than 0.05, while only reducing τ_{IR} by ˜0.1 for the 2 mm thick samples. Due to the difference between pure ZnS considered in our earlier model and the commercially available ZnS powder, two theoretical curves (solid line: pure ZnS and dashed line: SACHTOLITH HD-S) accounting for the optical properties of each powders are plotted in FIG. 25B. The optical properties of the pure ZnS powder were obtained using Mie theory (as in FIGS. 24A-24B) while those of SACHTOLITH HD-S were estimated by accounting for the presence of 3 wt. % BaSO₄ contaminants in the powder. Good agreement is observed between the experimental and theoretical solar transmittance, while some discrepancies, especially at larger ZnS concentrations, are observed for the IR transmittance. We first attribute the difference in IR transmittance between the pure ZnS and the experimental results to the presence of IR absorbing and scattering contaminants in the experimental ZnS powder. It was also noted that possible aggregation of nanoparticles in the experiments could lead to stronger scattering in the IR, further decreasing the measured IR transmittance and could break down the assumption of independent scattering in the model. Overall, the theoretical and experimental results show that the optical selectivity of PEA covers can be improved by adding small quantities of commercially available ZnS powder, and that even greater optical selectivity could be achieved by using 100% pure ZnS powder, paving the way for better sub-ambient radiative cooling under direct sunlight.

Improved Cooling Performance Using PEA+ZnS Covers

It was now demonstrated that the optical properties of PEA covers could be altered by adding solar scattering and infrared transparent nanoparticles such as ZnS. Next, it is shown how these OSTI covers with better optically selectivity can improve the sub-ambient cooling power of radiative cooling.

FIG. 26A shows the cooling power of a blackbody emitter (Tₑₘᵢₜₜₑᵣ−T_{ambient}=−5 K) under direct sunlight (Qₛᵤₙ=1000 W/m²) and the U.S. Standard 1976 sky shielded by a 5 mm thick PEA+ZnS cover. Similar to FIGS. 24A-24B, various ZnS particle diameters (0.1-1.5 μm) and concentrations (0-150 kg/m³) are considered for the PEA+ZnS cover. As illustrated in FIG. 26A, no cooling (P_{cool}=−33 W/m²) is achieved with a conventional PEA cover (C_{ZnS}=0 kg/m³; No ZnS dashed line) due to significant solar absorption at the emitter. Increasing ZnS concentration however reduces solar absorption at the emitter, enabling higher cooling power until a reduction in IR transmittance causes it to plateau and then decrease. The influence of ZnS particle size again shows that an optimum particle size around 0.3-0.7 μm (depending on C_{ZnS}) maximizes cooling power. A maximum cooling power of P_{cool}=25 W/m² (d_{ZnS}=0.3 μm; C_{ZnS}=150 kg/m³) is achieved within the range of parameters considered, representing a 58 W/m² increase in cooling power over the pure PEA cover case and demonstrating the potential of the approach to increase the cooling performance of daytime radiative coolers. A similar simulation was also performed for similar conditions but with an ideal selective emitter having an emissivity of ε=1 between 8-13 μm and a reflectivity ρ=1 at all other wavelengths. In this case, the cooling performance is not affected by solar absorption at the emitter because of its optical selectivity. Thus, the addition of ZnS to the cover has a limited effect on the emitter cooling power. A slight increase in cooling power with increasing ZnS concentration is observed for a few particle diameters (0.3-0.7 μm), which can be attributed to a reduction in parasitic conduction of heat absorbed from the sun within the OSTI and transported to the sub-ambient emitter. These results suggest that the improved optical selectivity of the cover is, as expected, more important for non-selective emitters. However, the ability to achieve near equal cooling power with a blackbody emitter and an ideal selective emitter when combined with a PEA+ZnS cover suggests that the solar optical properties of emitter no longer are the dominant parameter determining the cooling performance of the device. As such, the optimized OSTI cover could be applied to any IR emissive surface to provide sub-ambient cooling irrespective of its optical properties in the solar spectrum, which could be attractive as a retrofit solution or could help reduce the emitter complexity and cost. Finally, the increased optical selectivity of the cover can help decrease the required thickness to achieve net cooling, which could reduce the cover's cost. Optimizing ZnS Distribution within PEA

The discussion above has assumed a uniform ZnS distribution within PEA for simplicity of modeling and fabrication. It is possible that the addition of dopant in the aerogel can affect the thermal conductivity of the aerogel. If the dopant does affect the solid conduction of the aerogel, then it can be even more important to optimize the distribution of ZnS within the aerogel. For example, it can be possible to concentrate all the ZnS as far as possible from the emitter. The distribution profile of the dopant can be affected by its effect on the thermal conductivity of the aerogel. The addition of ZnS within PEA however raises the cover's internal temperature due to an increased parasitic solar absorption by the ZnS nanoparticles. This increased OSTI cover temperature in turn increases the parasitic heat conduction to the colder emitter through the cover which decreases cooling power, as shown in FIG. 26B. Ideally, one would like to suppress all parasitic solar absorption by the cover or spatially confine it as far as possible from the emitter (i.e., closer to the ambient air) to minimize this parasitic conductive heat gain. The impact of non-uniform ZnS distributions within the cover was evaluated to see if it can enable higher cooling power for a sub-ambient emitter.

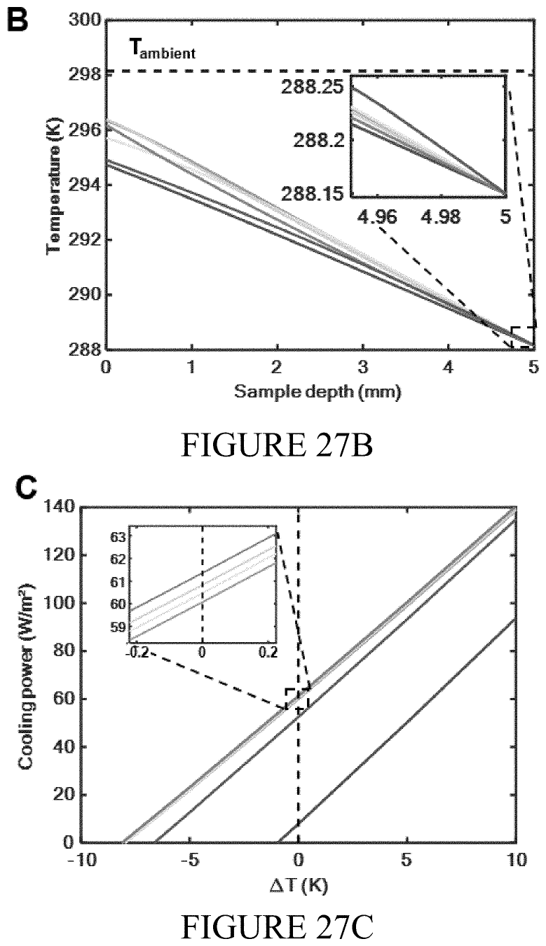

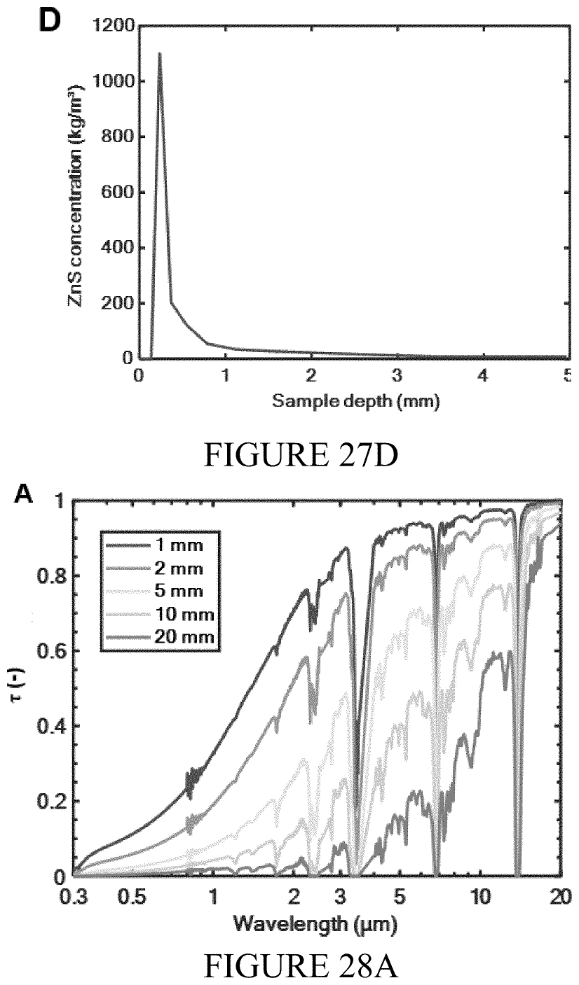

FIG. 27A depicts six different ZnS distribution profiles: No ZnS, Constant, Linear+, Linear−, Top only, Emitter only. The ZnS distribution profiles assume a particle diameter of 0.5 μm and a fixed total amount of ZnS—equivalent to a uniform concentration of 68 kg/m³ corresponding to the concentration for maximum cooling power at that particle diameter (see FIG. 26A). Under conditions similar to those in FIG. 26A, the daytime emitter cooling power was calculated for the different ZnS distribution profiles. The resulting temperature profiles and cooling powers are shown in FIGS. 27B and 27C, respectively. It was observed that all ZnS distributions increase the cover temperature as well as the temperature gradient near the emitter (see inset in FIG. 27B) compared to the No ZnS case. While the Bottom only distribution achieves the lowest temperature rise, it has the highest emitter-side temperature gradient (i.e., larger conductive heat gain at the emitter) of all ZnS distribution profiles. On the other hand, lower temperature gradients near the emitter (i.e., smaller conductive heat gains at the emitter) are achieved by covers with ZnS concentrated farther away from the emitter, such as the Top only cover. The effect of ZnS distribution within the OSTI cover is further clarified in FIG. 27C where the cooling power of each cover is compared. While all ZnS covers greatly surpass the No ZnS cover in terms of cooling power, small differences are observed amongst the different ZnS distribution profiles. As suggested by the temperature profile in FIG. 27B, covers localizing ZnS farther away from the emitter achieve higher cooling power, with the Top only case providing the highest cooling power (23.2 W/m² at ΔT=−5K), representing a 1.1 W/m² (4.7%) improvement over the Constant profile case (22.1 W/m² at ΔT=−5K). Based on these analyses, we seek to further optimize the ZnS distribution within the cover to maximize the cooling power. The optimization was performed by dividing the cover in 30 layers in which the layers' concentration can independently be modified between 0 and 10,000 kg/m³. The resulting ZnS distribution profile of the optimization is presented in FIG. 27DD, showing a higher ZnS concentration near the ambient air and close to zero concentration near the emitter. The optimized ZnS distribution yields a cooling power of 27.6 W/m² at ΔT=−5K, representing a 5.5 W/m² (23.7%) improvement over the Constant profile, while using 23.5% less ZnS. Our results indicate that while ZnS pigmentation of PEA can improve the sub-ambient cooling performance, an optimized ZnS distribution profile gives the best performance while using less ZnS which could help reduce the overall cover cost.

As discussed herein, it is possible to improve the optical selectivity of existing PEA OSTI covers by adding solar scattering and infrared transparent ZnS nanoparticles. Using Mie theory to predict the optical properties of ZnS nanoparticles and solving the RTE, it was theoretically demonstrated that ZnS addition in PEA could reduce the cover's solar transmittance to well below 0.01 while maintaining high IR transmittance (>0.8). This increased optical selectivity was further demonstrated experimentally using PEA samples pigmented with commercially available ZnS nanoparticles (SACHTOLITH HD-S). It was then shown that this increased optical selectivity could drastically improve the sub-ambient cooling performance of radiative coolers. More specifically, it was calculated that using a 5 mm thick PEA+ZnS cover, one could could achieve a cooling power of up to 27.6 W/m² with a blackbody emitter at 5 K below the ambient temperature, which was similar to an ideal emitter with a similar cover and 61 W/m² higher than an unpigmented PEA cover. These results show the promise of improving the sub-ambient cooling performance of radiative coolers by decoupling the emitter solar optical properties from the system's performance. Furthermore, the added optical selectivity of the cover can reduce the required OSTI cover thickness and cost required to achieve sub-ambient cooling using non-selective surfaces. Finally, it was demonstrated that using non-uniform ZnS distributions within the PEA cover could reduce the total mass of ZnS required while still yielding superior cooling. This work could improve the performance of existing radiative coolers and enable new applications such as passive cooling of buildings and passive refrigeration of food produce.

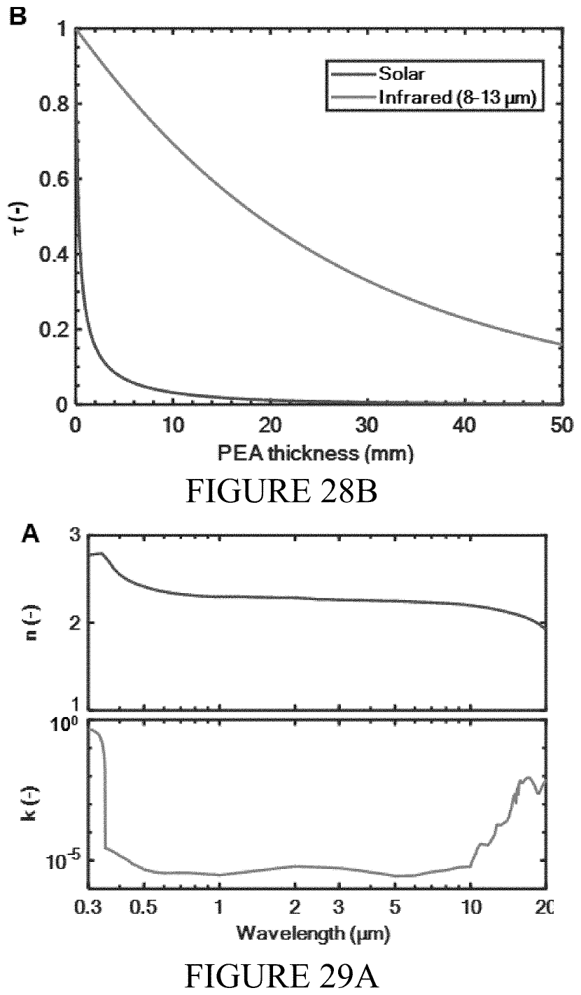

FIGS. 28A-28B show transmittance of PEA samples of different thicknesses. Spectra were calculated using the RTE model based on the experimentally determined optical properties of PEA. Solar and IR (8-13 μm) weighed optical properties of PEA are shown as a function of thickness.

FIGS. 29A-29B show real (top) and imaginary (bottom) part of the refractive index of ZnS and scattering (C_{sca}; top) and absorption (C_{abs}; bottom) cross section of ZnS particles of different diameters, respectively.

It should be understood that the subject matter defined in the appended claims is not necessarily limited to the specific implementations described above. The specific implementations described above are disclosed as examples only.

### BIBLIOGRAPHY

1. International Energy Agency, “The Future of Cooling: Opportunities for energy-efficient air conditioning” (2018), (available at https://webstore.iea.org/the-future-of-cooling).
2. J. A. Foley et al., Solutions for a cultivated planet. Nature. 478, 337-342 (2011).
3. F. Trombe, Perspectives sur l'utilisation des rayonnements solaires et terrestres dans certaines régions du monde. Rev. Générale Therm. 6, 1285-1314 (1967).
4. A. W. Harrison, M. R. Walton, Radiative cooling of TiO2 white paint. Sol. Energy. 20, 185-188 (1978).
5. A. Hjortsberg, C. G. Granqvist, Radiative cooling with selectively emitting ethylene gas. Appl. Phys. Lett. 39, 507-509 (1981).
6. E. M. Lushiku, A. Hjortsberg, C. G. Granqvist, Radiative cooling with selectively infrared-emitting ammonia gas. J. Appl. Phys. 53, 5526-5530 (1982).
7. A. R. Gentle, G. B. Smith, Radiative Heat Pumping from the Earth Using Surface Phonon Resonant Nanoparticles. Nano Lett. 10, 373-379 (2010).
8. L. Zhu, A. Raman, S. Fan, Color-preserving daytime radiative cooling. Appl. Phys. Lett. 103, 223902 (2013).
9. A. P. Raman, M. A. Anoma, L. Zhu, E. Rephaeli, S. Fan, Passive radiative cooling below ambient air temperature under direct sunlight. Nature. 515, 540-544 (2014).
10. A. R. Gentle, G. B. Smith, A Subambient Open Roof Surface under the Mid-Summer Sun. Adv. Sci. 2, 1500119 (2015).
11. L. Zhu, A. P. Raman, S. Fan, Radiative cooling of solar absorbers using a visibly transparent photonic crystal thermal blackbody. Proc. Natl. Acad. Sci. 112, 6-11 (2015).
12. Z. Chen, L. Zhu, A. Raman, S. Fan, Radiative cooling to deep sub-freezing temperatures through a 24-h day-night cycle. Nat. Commun. 7, 13729 (2016).
13. Y. Zhai et al., Scalable-manufactured randomized glass-polymer hybrid metamaterial for daytime radiative cooling. Science (80-.). 355, 1062-1066 (2017).
14. A. R. Gentle, A. Nuhoglu, M. D. Arnold, G. B. Smith, in Thermal Radiation Management for Energy Applications, M. M. Al-Jassim, P. Bermel, Eds. (SPIE, 2017; https://www.spiedigitallibrary.org/conference-proceedings-of-spie/10369/2274568/3D-printable-optical-structures-for-sub-ambient-sky-cooling/10.1117/12.2274568.full), p. 10.
15. J. Kou, Z. Jurado, Z. Chen, S. Fan, A. J. Minnich, Daytime Radiative Cooling Using Near-Black Infrared Emitters. ACS Photonics. 4, 626-630 (2017).
16. E. A. Goldstein, A. P. Raman, S. Fan, Sub-ambient non-evaporative fluid cooling with the sky. Nat. Energy. 2, 17143 (2017).
17. B. Bhatia et al., Passive directional sub-ambient daytime radiative cooling. Nat. Commun. 9, 5001 (2018).
18. H. Kim, A. Lenert, Optical and thermal filtering nanoporous materials for sub-ambient radiative cooling. J. Opt. 20, 084002 (2018).
19. D. Zhao et al., Subambient Cooling of Water: Toward Real-World Applications of Daytime Radiative Cooling. Joule. 3, 111-123 (2019).
20. H. Kim, A. Lenert, in Proceedings of the 16th International Heat Transfer Conference (Beijing, 2018), pp. 1-8.
21. P. Yang, C. Chen, Z. M. Zhang, A dual-layer structure with record-high solar reflectance for daytime radiative cooling. Sol. Energy. 169, 316-324 (2018).
22. J. Mandal et al., Hierarchically porous polymer coatings for highly efficient passive daytime radiative cooling. Science (80-.). 362, 315-319 (2018).
23. B. Zhao, M. Hu, X. Ao, N. Chen, G. Pei, Radiative cooling: A review of fundamentals, materials, applications, and prospects. Appl. Energy. 236, 489-513 (2019).
24. L. Zhu, A. Raman, K. X. Wang, M. A. Anoma, S. Fan, Radiative cooling of solar cells. Optica. 1, 32-38 (2014).
25. A. R. Gentle, G. B. Smith, Radiative Heat Pumping from the Earth Using, 373-379 (2010).
26. E. M. Lushiku, A. Hjortsberg, C. G. Granqvist, Radiative cooling with selectively infrared-emitting ammonia gas. J. Appl. Phys. 53, 5526-5530 (1982).
27. Z. Chen, L. Zhu, W. Li, S. Fan, Simultaneously and Synergistically Harvest Energy from the Sun and Outer Space. Joule, 1-10 (2018).
28. N. A. Nilsson, T. S. Eriksson, C. G. Granqvist, Infrared-transparent convection shields for radiative cooling: Initial results on corrugated polyethylene foils. Sol. Energy Mater. 12, 327-333 (1985).
29. A. R. Gentle, K. L. Dybdal, G. B. Smith, Polymeric mesh for durable infra-red transparent convection shields: Applications in cool roofs and sky cooling. Sol. Energy Mater. Sol. Cells. 115, 79-85 (2013).
30. S. N. Bathgate, S. G. Bosi, A robust convection cover material for selective radiative cooling applications. Sol. Energy Mater. Sol. Cells. 95, 2778-2785 (2011).
31. M. Benlattar, E. M. Oualim, M. Harmouchi, A. Mouhsen, A. Belafhal, Radiative properties of cadmium telluride thin film as radiative cooling materials. Opt. Commun. 256, 10-15 (2005).
32. A. Berk et al., in Proceeding of SPIE 9088, Algorithms and Technologies for Multispectral, Hyperspectral, and Ultraspectral Imagery XX, M. Velez-Reyes, F. A. Kruse, Eds. (2014; http://proceedings.spiedigitallibrary.org/proceeding.aspx?doi=10.1117/12.2050433), p. 90880H.
33. J. Gulmine, P. Janissek, H. Heise, L. Akcelrud, Polyethylene characterization by FTIR. Polym. Test. 21, 557-563 (2002).
34. P.-C. Hsu et al., Radiative human body cooling by nanoporous polyethylene textile. Science (80-.). 353, 1019-1023 (2016).
35. Y. A. Attia, Polyethylene aerogels and method of their production (2015), p. 11.
36. C. Daniel, S. Longo, G. Guerra, High porosity polyethylene aerogels. 2, 49-55 (2015).
37. K. Stamnes, G. E. Thomas, J. J. Stamnes, Radiative Transfer in the Atmosphere and Ocean (Cambridge University Press, Cambridge, 2017; http://ebooks.cambridge.org/ref/id/CBO9781316148549).
38. L. Zhao, S. Yang, B. Bhatia, E. Strobach, E. N. Wang, Modeling silica aerogel optical performance by determining its radiative properties. AIP Adv. 6 (2016), doi:10.1063/1.4943215.
39. ASTM International, “ASTM C1044-16 Standard Practice for Using a Guarded-Hot-Plate Apparatus or Thin-Heater Apparatus in the Single-Sided Mode” (West Conshohocken, Pa., 2016), doi:10.1520/C1044-16.
40. Y. Tu, R. Wang, Y. Zhang, J. Wang, Progress and Expectation of Atmospheric Water Harvesting. Joule. 2, 1452-1475 (2018).
41. C. I. Ezekwe, Performance of a heat pipe assisted night sky radiative cooler. Energy Convers. Manag. 30, 403-408 (1990).
42. E. Sartori, Convection coefficient equations for forced air flow over flat surfaces. Sol. Energy. 80, 1063-1071 (2006).
43. C. Daniel, S. Longo, G. Guerra, High porosity polyethylene aerogels, Polyolefins J. 2 (2015) 49-55. https://doi.org/10.22063/POJ.2015.1113.
44. Y. A. Attia, Polyethylene aerogels and method of their production, U.S. Pat. No. 9,034,934 B1, 2015.
45. H. Kim, A. Lenert, Optical and thermal filtering nanoporous materials for sub-ambient radiative cooling, J. Opt. 20 (2018) 084002. https://doi.org/10.1088/2040-8986/aacaal.
46. A. Leroy, B. Bhatia, C. C. Kelsall, A. Castillejo-Cuberos, M. Di Capua H., L. Zhao, L. Zhang, A. M. Guzman, E. N. Wang, High-performance subambient radiative cooling enabled by optically selective and thermally insulating polyethylene aerogel, Sci. Adv. 5 (2019) eaat9480. https://doi.org/10.1126/sciadv.aat9480.
47. M. Yang, W. Zou, J. Guo, Z. Qian, H. Luo, S. Yang, N. Zhao, Bioinspired “Skin” with Cooperative Thermo-Optical Effect for Daytime Radiative Cooling, (2020). https://doi.org/10.1021/acsami.0c03897.
48. W. M. Rohsenow, J. P. Hartnett, E. N. Ganic, Handbook of Heat Transfer Fundamentals, 2nd ed., Mcgraw-Hill, New York, 1985.
49. M. Alvarez-Lainez, M. A. Rodriguez-Perez, J. A. De Saja, Thermal Conductivity of Open-Cell Polyolefin Foams, J. Polym. Sci. Part B Polym. Phys. 46 (2008) 212-221. https://doi.org/https://doi.org/10.1002/polb.21358.
50. Y. L. He, T. Xie, Advances of thermal conductivity models of nanoscale silica aerogel insulation material, Appl. Therm. Eng. 81 (2015) 28-50. https://doi.org/10.1016fj.applthermaleng.2015.02.013.
51. L. W. Hrubesh, R. W. Pekala, Thermal properties of organic and inorganic aerogels, J. Mater. Res. 9 (1994) 731-738. https://doi.org/10.1557/JMR.1994.0731.
52. G. Wei, Y. Liu, X. Zhang, F. Yu, X. Du, Thermal conductivities study on silica aerogel and its composite insulation materials, Int. J. Heat Mass Transf. 54 (2011) 2355-2366. https://doi.org/10.1016/j.ijheatmasstransfer.2011.02.026.
53. L. R. Glicksman, Low density cellular plastics: Physical basis of behavior, in: N. C. Hilyard, A. Cunningham (Eds.), Low Density Cell. Plast. Phys. Basis Behav., First, Springer Science+Business Media, 1994: pp. 104-152. https://doi.org/10.1007/978-94-011-1256-7.
54. S. Q. Zeng, A. Hunt, R. Greif, Geometric Structure and Thermal Conductivity of Porous Medium Silica Aerogel, J. Heat Transfer. 117 (1995) 1055-1058. https://doi.org/10.1115/1.2836281.
55. T. Xie, Y. He, Z. Hu, Theoretical study on thermal conductivities of silica aerogel composite insulating material, Int. J. Heat Mass Transf. 58 (2013) 540-552. https://doi.org/10.1016j.ijheatmasstransfer.2012.11.016.
56. S. S. Sundarram, W. Li, On Thermal Conductivity of Micro- and Nanocellular Polymer Foams, Polym. Eng. Sci. 53 (2013) 1901-1909. https://doi.org/10.1002/pen.23452.
57. C. Bi, G. H. Tang, Effective thermal conductivity of the solid backbone of aerogel, Int. J. Heat Mass Transf. 64 (2013) 452-456. https://doi.org/10.1016j.ijheatasstransfer.2013.04.053.
58. M. A. Rodriguez-perez, J. La, A. De Saja, Influence of Solid Phase Conductivity and Cellular Structure on the Heat Transfer Mechanisms of Cellular Materials: Diverse Case Studies ** By Eusebio Solo, (2009) 818-824. https://doi.org/10.1002/adem.200900138.
59. B. Notario, J. Pinto, E. Solorzano, J. A. De Saja, M. Dumon, Experimental validation of the Knudsen effect in nanocellular polymeric foams, 56 (2015) 57-67. https://doi.org/10.1016/j.polymer.2014.10.006.
60. P. Gong, P. Buahom, M. Tran, M. Saniei, C. B. Park, P. Po, Heat transfer in microcellular polystyrene/multi-walled carbon nanotube nanocomposite foams, 3 (2015). https://doi.org/10.1016fj.carbon.2015.06.003.
61. D. W. Van Krevelen, K. Te Nijenhuis, Transport of Thermal Energy, Prop. Polym. (2009) 645-653. https://doi.org/10.1016/B978-0-08-054819-7.00017-0.
62. J. Antonio, R. Ruiz, C. Saiz-arroyo, M. Dumon, M. A. Rodr, L. Gonzalez, Production, cellular structure and thermal conductivity of microcellular (methyl methacrylate)-(butyl acrylate)-(methyl methacrylate) triblock copolymers, (2011) 146-152. https://doi.org/10.1002/pi.2931.
63. M. G. Kaganer, Thermal insulation in cryogenic engineering, 1st ed., Israel Program for Scientific Translations, Jerusalem, 1969.
64. S. Q. Zeng, A. Hunt, R. Greif, Mean free path and apparent thermal conductivity of a gas in a porous medium, J. Heat Transfer. 117 (1995) 758-761. https://doi.org/10.1115/1.2822642.
65. G. Reichenauer, U. Heinemann, H. P. Ebert, Relationship between pore size and the gas pressure dependence of the gaseous thermal conductivity, Colloids Surfaces A Physicochem. Eng. Asp. 300 (2007) 204-210. https://doi.org/10.1016j.colsurfa.2007.01.020.
66. C. Bi, G. H. Tang, W. Q. Tao, Prediction of the gaseous thermal conductivity in aerogels with non-uniform pore-size distribution, 358 (2012) 3124-3128. https://doi.org/10.1016fj.jnoncrysol.2012.08.011.
67. K. Swimm, G. Reichenauer, S. Vidi, H. P. Ebert, Impact of thermal coupling effects on the effective thermal conductivity of aerogels, J. Sol-Gel Sci. Technol. 84 (2017) 466-474. https://doi.org/10.1007/s10971-017-4437-5.
68. K. Swimm, S. Vidi, G. Reichenauer, H. Ebert, Coupling of gaseous and solid thermal conduction in porous solids Solid phase Gas phase Solid phase, J. Non. Cryst. Solids. 456 (2017) 114-124. https://doi.org/10.1016j.jnoncrysol.2016.11.012.
69. National Institute of Standards and Technology, NIST Reference Fluid Thermodynamic and Transport Properties Database (REFPROP), (n.d.).
70. G. W. Ball, R. Hurd, M. G. Walker, The Thermal Conductivity on Rigid Urethane Foams, J. Cell. Plast. 6 (1970) 66-75. https://doi.org/10.1177/0021955X7000600202.
71. X. Lu, R. Caps, J. Fricke, C. T. Alviso, R. W. Pekala, Correlation between structure and thermal conductivity of organic aerogels, J. Non. Cryst. Solids. 188 (1995) 226-234. https://doi.org/10.1016/0022-3093(95)00191-3.
72. T. Xie, Y. He, Heat transfer characteristics of silica aerogel composite materials: Structure reconstruction and numerical modeling, Int. J. Heat Mass Transf. 95 (2016) 621-635. https://doi.org/10.1016j.ijheatmasstransfer.2015.12.025.
73. U. Heinemann, R. Caps, J. Fricke, Radiation-conduction interaction: An investigation on silica aerogels, Int. J. Heat Mass Transf. 39 (1996) 2115-2130. https://doi.org/10.1016/0017-9310(95)00313-4.
74. K. Stamnes, G. E. Thomas, J. J. Stamnes, Radiative Transfer in the Atmosphere and Ocean, Cambridge University Press, Cambridge, 2017. https://doi.org/10.1017/9781316148549.
75. L. Zhao, S. Yang, B. Bhatia, E. Strobach, E. N. Wang, Modeling silica aerogel optical performance by determining its radiative properties, AIP Adv. 6 (2016). https://doi.org/10.1063/1.4943215.
76. M. F. Modest, Radiative heat transfer, Academic press, 2013.
77. ASTM International, ASTM C1044-16 Standard Practice for Using a Guarded-Hot-Plate Apparatus or Thin-Heater Apparatus in the Single-Sided Mode, West Conshohocken, Pa., 2016. https://doi.org/10.1520/C1044-16.
78. O.-J. Lee, K.-H. Lee, T. Jin, S. Young, T. Jin Yim, S. Young Kim, K.-P. Yoo, Determination of mesopore size of aerogels from thermal conductivity measurements, J. Non. Cryst. Solids. 298 (2002) 287-292. https://doi.org/10.1016/S0022-3093(01)01041-9.
79. F. Trombe, Rev. Générale Therm. 6, 1285 (1967).
80. A. R. Gentle and G. B. Smith, Nano Lett. 10, 373 (2010).
81. L. Zhu, A. Raman, K. X. Wang, M. A. Anoma, and S. Fan, Optica 1, 32 (2014).
82. A. P. Raman, M. A. Anoma, L. Zhu, E. Rephaeli, and S. Fan, Nature 515, 540 (2014).
83. A. R. Gentle and G. B. Smith, Adv. Sci. 2, 1500119 (2015).
84. P. Bermel, S. V Boriskina, Z. Yu, and K. Joulain, 23, 1533 (2015).
85. P.-C. Hsu, A. Y. Song, P. B. Catrysse, C. Liu, Y. Peng, J. Xie, S. Fan, and Y. Cui, Science (80-.). 353, 1019 (2016).
86. Z. Chen, L. Zhu, A. Raman, and S. Fan, Nat. Commun. 7, 13729 (2016).
87. E. A. Goldstein, A. P. Raman, and S. Fan, Nat. Energy 2, 17143 (2017).
88. J. Mandal, Y. Fu, A. C. Overvig, M. Jia, K. Sun, N. N. Shi, H. Zhou, X. Xiao, N. Yu, and Y. Yang, Science (80-.). 362, 315 (2018).
89. Y. Peng, J. Chen, A. Y. Song, P. B. Catrysse, P. C. Hsu, L. Cai, B. Liu, Y. Zhu, G. Zhou, D. S. Wu, H. R. Lee, S. Fan, and Y. Cui, Nat. Sustain. 1, 105 (2018).
90. L. Cai, A. Y. Song, W. Li, P. C. Hsu, D. Lin, P. B. Catrysse, Y. Liu, Y. Peng, J. Chen, H. Wang, J. Xu, A. Yang, S. Fan, and Y. Cui, Adv. Mater. 30, 1 (2018).
91. A. Leroy, B. Bhatia, C. C. Kelsall, A. Castillejo-Cuberos, M. Di Capua H., L. Zhao, L. Zhang, A. M. Guzman, and E. N. Wang, Sci. Adv. 5, eaat9480 (2019).
92. D. Zhao, A. Aili, Y. Zhai, J. Lu, D. Kidd, G. Tan, X. Yin, and R. Yang, Joule 3, 111 (2019).
93. D. Zhao, A. Aili, Y. Zhai, S. Xu, G. Tan, X. Yin, and R. Yang, Appl. Phys. Rev. 6, (2019).
94. H. Kim and A. Lenert, (2018).
95. H. Kim and A. Lenert, in Proc. 16th Int. Heat Transf. Conf. (Beijing, 2018), pp. 1-8.
96. H. Kim and A. Lenert, J. Opt. 20, 084002 (2018).
97. J. K. Tong, X. Huang, S. V. Boriskina, J. Loomis, Y. Xu, and G. Chen, ACS Photonics 2, 769 (2015).
98. T. Gao, Z. Yang, C. Chen, Y. Li, K. Fu, J. Dai, E. M. Hitz, H. Xie, B. Liu, J. Song, B. Yang, and L. Hu, ACS Nano 11, 11513 (2017).
99. P.-C. Hsu, A. Y. Song, P. B. Catrysse, C. Liu, Y. Peng, J. Xie, S. Fan, and Y. Cui, Science (80-.). 353, 1019 (2016).
100. L. Cai, Y. Peng, J. Xu, C. Zhou, C. Zhou, P. Wu, D. Lin, S. Fan, and Y. Cui, Joule 3, 1478 (2019).
101. J. Mandal, Y. Fu, A. C. Overvig, M. Jia, K. Sun, N. N. Shi, H. Zhou, X. Xiao, N. Yu, and Y. Yang, Science (80-.). 362, 315 (2018).
102. T. M. J. Nilsson, G. A. Niklasson, and C. G. Granqvist, Sol. Energy Mater. Sol. Cells 28, 175 (1992).
103. T. M. J. Nilsson and G. a. Niklasson, Sol. Energy Mater. Sol. Cells 37, 93 (1995).
104. Y. Mastai, Y. Diamant, S. T. Aruna, and A. Zaban, Langmuir 17, 7118 (2001).
105. G. A. Niklasson and T. S. Eriksson, Opt. Mater. Technol. Energy Effic. Sol. Energy Convers. VII 1016, 89 (1989).
106. E. D. Palik and A. Addamanio, in Handb. Opt. Constants Solids (Washington, D.C., 1998), pp. 597-619.
107. K. Stamnes, G. E. Thomas, and J. J. Stamnes, Radiative Transfer in the Atmosphere and Ocean (Cambridge University Press, Cambridge, 2017).
108. M. F. Modest, Radiative Heat Transfer (Academic press, 2013).
109. L. Zhao, S. Yang, B. Bhatia, E. Strobach, and E. N. Wang, AlP Adv. 6, (2016).
110. C. F. Bohren, Absorpt. Scatt. Light by Small Part. (1983).
111. K. Stamnes, S.-C. Tsay, W. Wiscombe, and K. Jayaweera, Appl. Opt. 27, 2502 (1988).
112. A. Berk, P. Conforti, R. Kennett, T. Perkins, F. Hawes, and J. van den Bosch, in Proceeding SPIE 9088, Algorithms Technol. Multispectral, Hyperspectral, Ultraspectral Imag. XX, edited by M. Velez-Reyes and F. A. Kruse (2014), p. 90880H.
113. G. Auer, W.-D. Griebler, and B. Jahn, in Ind. Inorg. Pigment. (Wiley-VCH Verlag GmbH & Co. KGaA, Weinheim, F R G, 2005), pp. 51-97.
114. D. E. Chasan and G. Norwitz, Infrared Determination of Inorganic Sulfates and Carbonates by the Pellet Technique (Philadelphia, 1969).

Other embodiments are within the scope of the following claims.

What is claimed is:

1. A polyethylene aerogel formed from an initial polymer concentration selected to maximize solar reflectivity, infrared transmittance and structural integrity of the gel.

2. An optically selective and thermally insulating polyethylene aerogel.

3. The optically selective and thermally insulating polyethylene aerogel of claim 2, wherein the polyethylene aerogel has a low thermal conductivity of approximately about 28±5 mW/mK.

4. The optically selective and thermally insulating polyethylene aerogel of claim 2, wherein the polyethylene aerogel has a thickness greater than about one-half centimeter.

5. The optically selective and thermally insulating polyethylene aerogel of claim 2, wherein the polyethylene aerogel, in the atmospheric transparency spectral window of approximately 8-13 μm, has a high transmittance.

6. The optically selective and thermally insulating polyethylene aerogel of claim 5, wherein the transmittance is greater than 70%.

7. The optically selective and thermally insulating polyethylene aerogel of claim 2, wherein the polyethylene aerogel is solar reflecting, infrared transparent and low thermal conductivity.

8. The optically selective and thermally insulating polyethylene aerogel of claim 2, wherein the polyethylene aerogel has a thickness between about 50 microns and about 100 mm.

9. The optically selective and thermally insulating polyethylene aerogel of claim 2, wherein the polyethylene aerogel has a thickness greater than 100 microns and less than 35 mm.

10. The optically selective and thermally insulating polyethylene aerogel of claim 2, wherein the polyethylene aerogel has an average pore size of less than 10 microns.

11. The optically selective and thermally insulating polyethylene aerogel of claim 2, further comprising a dopant dispersed in the aerogel.

12. The optically selective and thermally insulating polyethylene aerogel of claim 11, wherein the dopant includes a material that has low absorption in the 8-13 μm range.

13. The optically selective and thermally insulating polyethylene aerogel of claim 11, wherein the dopant includes a plurality of particles.

14. The optically selective and thermally insulating polyethylene aerogel of claim 13, wherein the plurality of particles are distributed evenly throughout the aerogel.

15. The optically selective and thermally insulating polyethylene aerogel of claim 13, wherein the plurality of particles are distributed in a gradient through a thickness of the aerogel.

16. The optically selective and thermally insulating polyethylene aerogel of claim 13, wherein the plurality of particles have an average diameter of between 0.1 and 2 microns.

17. The optically selective and thermally insulating polyethylene aerogel of claim 11, wherein the dopant includes ZnS, TiO₂, ZnO, ZnSe, KBr, NaCl, Zr₂, GeAsSe, BaF₂, CsI, CdTe, diamond, Ge, Si, or AgCl.

18. A radiative cooling system comprising the optically selective and thermally insulating polyethylene aerogel of claim 2.

19. A method of radiative cooling comprising providing the optically selective and thermally insulating polyethylene aerogel of claim 2 on a surface of a radiation emitter.

20. A method of making a radiative cooler comprising providing the optically selective and thermally insulating polyethylene aerogel of claim 2 on a surface of a radiation emitter.
